(19) United States
(12) Patent Application Publication
(10) Pub. No.: US 2023/0297909 A1
(43) Pub. Date: Sep. 21, 2023

(54) SYSTEM AND METHOD FOR PREDICTING SERVICE METRICS USING HISTORICAL DATA

(71) Applicant: Nice Ltd., Ra'anana (IL)

(72) Inventors: Noam KAPLAN, Tel Aviv (IL); Ying ZHANG, Collierville, TN (US); Gennadi LEMBERSKY, Haifa (IL); Nick MARTIN, Plano, TX (US); Eyal SEGAL, Ramat Gan (IL)

(73) Assignee: Nice Ltd., Ra'anana (IL)

(21) Appl. No.: 18/096,732

(22) Filed: Jan. 13, 2023

Related U.S. Application Data
(63) Continuation-in-part of application No. 17/694,784, filed on Mar. 15, 2022.

(51) Int. Cl. G06Q 10/0631

(52) U.S. Cl. CPC G06Q 10/063112; G06Q 10/06316

(57) ABSTRACT

Methods and systems for, upon receipt of a second computer data stream, predicting a change in processing a first computer data stream, include: receiving, at a computing device, the first computer data stream; generating a first data sequence comprising a time of receipt of the first computer data stream; receiving the second computer data stream; generating a second data sequence comprising a time of receipt of the second computer data stream; sending the first and second data sequences to a prediction model; predicting, by the prediction model, at least one change in at least one metric associated with processing the first computer data stream, the predicted change based at least in part on the first and second data sequences; and sending, by the prediction model, to the computing device, the at least one change in the at least one metric associated with processing the first computer data stream.

### CROSS-REFERENCE TO RELATED APPLICATIONS

This application continuation-in-part of U.S. patent application Ser. No. 17/694,784 filed Mar. 15, 2022, incorporated by reference herein in its entirety.

### FIELD OF THE INVENTION

The present invention relates generally to resource optimization, in particular to using combined search and predictive algorithms to schedule allocation of resources.

### BACKGROUND OF THE INVENTION

Contemporary systems exist to handle the problem of resource allocation, such as data streams or interactions, computer system resource allocation or generating staffing requirements (e.g. how many agents are needed in each time interval) in a voice only (e.g. communications between people using only voice) environment. The setting of voice calls only has been the main environment in which contact centers (also known as call centers) have operated. In the voice only setting, agents can handle only one contact at a certain time and will be available to handle another call only once the current call has been completed. The voice setting is in fact a sub-problem of generating staffing requirements under the constraint of maximum concurrency equal to 1.

However, the constraint of maximum concurrency equal to 1 has been relaxed in the digital contact center, where, for example, agents are expected to be able to concurrently handle a plurality of communications over multiple channels such as web chat, email, and short message service (SMS). This major shift in the way work is distributed and handled has great implications on both the number (and cost) of agents required at the contact center, as well as on the quality of service provided to the contacting customers.

Existing systems are not designed to handle this new way of work, accounting for the need of an agent to divide their full attention across multiple customers at a time, and therefore a new approach is needed to address the problem of generating staffing requirements for contact center agents in the digital contact center, handling multiple concurrent contacts over a multitude of different digital channels, such as web chat, email, short message service (SMS), WhatsApp, etc., as well as voice.

Many companies provide products that generate staffing requirements. These solutions, as well as the solutions provided by NICE Ltd., all rely on two main methods to approximate the needed staffing for a certain interval: the Erlang C formula, and simulations. These two methods have both been around for many decades, and while many improvements and adjustments have been made to them, in essence they are both bounded to the limitations of using average handling time (AHT) to approximate service level. While using these two solutions and relying on AHT has proved useful for many years, as seen before, in the digital and concurrent world these are not enough.

Both existing solutions lack the ability to capture the complexity of digital mediums, as well as the intricacies of different methods of using them, employed by different users. While in the past communications were limited to the voice medium, today a variety of channels are available. This new diversity in communication channels has opened the door to many new forms and methods of communication such as asynchronous communications, elevations between channels (e.g. a customer initially sending a chat message, but being later elevated to a voice call, perhaps because of the complexity of their problem), and many more. As a result, different users are using these channels in very different ways, resulting in very different meaning for the same volumes, for different tenants (e.g. the occupying company of a call centre). When trying to select an optimal concurrency value for different tenants, this approach makes it very hard to generalize a recommendation to all users.

### SUMMARY

Embodiments of the invention may relate to a method for, upon receipt of a second computer data stream, predicting a change in processing a first computer data stream, the method including: receiving, at a computing device, the first computer data stream; generating, by the computing device, a first data sequence which includes a time of receipt of the first computer data stream; receiving, at the computing device, the second computer data stream; generating, by the computing device, a second data sequence which includes a time of receipt of the second computer data stream; sending, by the computing device, the first and second data sequences to a prediction model; predicting, by the prediction model, at least one change in at least one metric associated with processing the first computer data stream, the predicted change based at least in part on the first data sequence and the second data sequence; and sending, by the prediction model, to the computing device, the at least one change in the at least one metric associated with processing the first computer data stream.

Embodiments of the invention may relate to a method for allocating resources for a plurality of time intervals, the method including: receiving a forecasted workload and at least one required service metric value for each of the plurality of time intervals; for each interval: applying a search algorithm to identify an initial allocation assignment; inputting the initial allocation assignment to a machine learning algorithm, wherein the machine learning algorithm has been previously trained on historic data of a plurality of past intervals; predicting, for each at least one required service metric, by the machine learning algorithm, an expected service metric value provided by the initial allocation assignment; adjusting, by the search algorithm, the initial allocation assignment based on a difference between the expected service metric value and the corresponding at least one required service metric value; iteratively repeating the applying, inputting, predicting, and adjusting operations until one of: the expected service metric value predicted for an adjusted allocation assignment is within a predetermined distance of the corresponding at least one required service metric value for the interval; or a predetermined time has elapsed.

According to an embodiment of the invention there is disclosed generating, from the iteratively adjusted allocation assignments, an allocation assignment plan for the plurality of time intervals. A plan may include data controlling or leading to the distribution of data such as interactions.

According to an embodiment of the invention, resources are classified by at least one skill.

According to an embodiment of the invention, the forecasted workload includes a workload broken down into one or more required resource skills for each of the plurality of time intervals.

According to an embodiment of the invention the forecasted workload includes a volume of incoming communications. Allocating resources may include distributing data streams, e.g. distributing interactions such as chat or voice data, across user or agent terminals, in order to have the data streams best serviced or handled.

According to an embodiment of the invention, at least one incoming communication is chosen from a list including: short message service (SMS), web chat, and email

According to an embodiment of the invention, at least one required service metric is chosen from a list including: average speed of answer, service level agreement, abandoned percentage, chat latency, and maximum occupancy.

According to an embodiment of the invention the adjusting is based on a correction ratio determined by the equation:

$$correction ratio = \frac{( 1 + Expected Service Metric Value )}{( 1 + Required Service Metric Value )} .$$

According to an embodiment of the invention, the machine learning algorithm is one of: a regression algorithm, a deep learning algorithm; a neural network; a fully connected neural network; or a convolutional neural network.

Embodiments may distribute data streams or interactions, and thus assign tasks and staffing. According to an embodiment of the invention, there is disclosed a method for optimizing workforce management plans in environments concurrently handling a plurality of voice and non-voice communications channels for a plurality of skills in a given time interval, the method including: receiving a workload and a required level of service; searching to identify an initial staffing assignment; predicting, by a machine learning algorithm, a predicted level of service expected for the initial staffing assignment, wherein the machine learning algorithm is trained on historic data of handling communications in past intervals; iteratively updating the staffing assignment based on a difference between the predicted level of service and the required level of service until: the level of service predicted for an updated staffing assignment is within a predetermined distance of the required level of service for the interval; or a time has elapsed.

According to an embodiment of the invention there is disclosed producing, from the iteratively updated staffing assignments, a staffing assignment plan or data distribution plan for the plurality of time intervals.

According to an embodiment of the invention, a non-voice communication includes any of: short message service, email, integrated chat, or social media message.

According to an embodiment of the invention, the workload includes a workload broken down by one or more required skills for each of the plurality of time intervals.

According to an embodiment of the invention, the initial staffing assignment is selected based on at least one of: Erlang C formulas, simulation, workload calculation, or random sampling.

According to an embodiment of the invention there is disclosed a system for allocating resources for a plurality of given time intervals, the system including: a memory; and a processor configured to: receive a forecasted workload and at least one required service metric value for each of the plurality of time intervals; for each interval: apply a search algorithm to identify an initial allocation assignment; apply a machine learning algorithm to the initial allocation assignment to predict, for each at least one required service metric, an expected service metric value provided by the initial allocation assignment; adjust the initial allocation assignment based on a difference between the expected service metric value and the corresponding at least one required service metric value; iteratively repeat the applying, predicting, and adjusting operations until either: the expected service metric value predicted for an adjusted allocation assignment is within a predetermined distance of the corresponding at least one required service metric value for the interval; or a predetermined time has elapsed.

According to an embodiment of the invention, the processor is configured to generate, from the iteratively adjusted allocation assignments, an allocation assignment plan for the plurality of time intervals.

According to an embodiment of the invention, the machine learning algorithm has been previously trained on historic data of a plurality of past intervals.

According to an embodiment of the invention, the processor classifies resources by at least one skill.

According to an embodiment of the invention, the received forecasted workload includes a workload broken down into at least two required resource skills for each of the plurality of time intervals.

According to an embodiment of the invention, the processor is configured to adjust the initial allocation assignment based on a correction ratio determined by the equation:

$$correction ratio = \frac{( 1 + Expected Service Metric Value )}{( 1 + Required Service Metric Value )} .$$

In contrast to existing methods, embodiments of the invention may provide an easy and clear way to account for different usage modes as well as other differences between tenants, simply through training and developing recommendations on tenant specific data.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a block diagram of a system according to an embodiment of the present invention;

FIG. 2 is a block diagram of a method according to an embodiment of the present invention;

FIG. 3 is a block diagram showing a focused view of elements of FIG. 2;

FIG. 4 is a block diagram showing a focused view of elements of FIG. 3;

FIG. 5 is a flow diagram of a method according to an embodiment of the invention;

FIG. 6 is a diagram showing the structure of a neural network according to an embodiment of the present invention;

FIG. 7 is a diagram showing the structure of a neural network according to an embodiment of the present invention;

FIG. 8 is a block diagram of a system according to an embodiment of the present invention;

FIG. 9 is a representation of a graphical user interface according to an embodiment of the present invention;

FIG. 10 is a block diagram of a system for processing data streams, according to some embodiments of the invention;

FIG. 11 is a flowchart of a computer implemented method for, upon receipt of a second data stream, predicting a change in processing a first data stream, according to some embodiments of the invention;

FIG. 12 is a schematic drawing of a system for predicting a change in processing a first computer data stream upon receipt of a second computer data stream, according to some embodiments of the invention;

FIG. 13 is a flowchart of a computer implemented method for directing incoming computer data streams in a network of computing devices, according to some embodiments of the invention;

FIG. 14A shows a regular and example simulation of agent availability, according to methods known in the art;

FIG. 14B shows an altered simulation to that of FIG. 14A, according to some embodiments of the invention;

FIG. 15 shows a visual representation of an agent concurrently handling three chats;

FIG. 16 shows an example architecture of a prediction model according to some embodiments of the invention;

FIG. 17 shows a high-level overview of how a system for predicting a change in processing a first computer data stream upon receipt of a second computer data stream may be integrated into a system for allocating resources for a plurality of given time intervals, according to some embodiments of the invention;

FIG. 18 shows a focused view of module B of FIG. 17; and

FIG. 19 is a diagram showing the structure of a neural network according to an embodiment of the present invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Embodiments of the invention relate generally to a novel method for approximating the quality of service provided by a set of agents for a specific time interval or time period. To predict while accounting for the great variability in service times, as well as their dependency on a myriad of different time dependent variables, a machine learning algorithm, e.g. a deep learning neural network, is trained on the data in a novel fashion. Furthermore, a novel search approach is applied over possible inputs to the trained model, leveraging the trained model as a means for selecting the optimal staffing requirement, so that the net staffing will be as low as possible while providing the required service levels. In some embodiments this may improve the technologies of machine learning. This algorithm differs from other existing methods in that it utilizes a resource unavailable until now, the historical data on workload, agents, and the contact center for service metric prediction.

As used herein, “Call Center” may refer to a centralized office used for receiving or transmitting a large volume of enquiries by telephone. An inbound call center may be operated by a company (e.g. a tenant) to administer incoming product or service support or information enquiries from consumers.

As used herein, “Contact Center” may refer to a call center which handles other types of communications other than voice telephone calls, for example, email, message chat, SMS, etc. Reference to call center should be taken to be applicable to contact center.

As used herein, an “Agent” may be a contact center employee that answers incoming contacts, handles customer requests and so on.

As used herein, a “Customer” may be the end user of a contact center. They may be customers of the company that require some kind of service or support.

As used herein, a “Digital Channel” may refer to a communication channel that provides alternatives or complementary methods of communication to traditional voice channels, such as web chat, email, short message service (SMS) and WhatsApp.

As used herein, “Work Force Management (WFM)” may refer to an integrated set of processes that a company uses to optimize the productivity of its employees. WFM involves effectively forecasting labor requirements and creating and managing staff schedules to accomplish a particular task on a day-to-day and hour-to-hour basis.

As used herein, “Staffing Requirements” may refer to the required amount of personnel (e.g. agents) needed at a contact center to handle expected contacts in accordance with quality-of-service metrics.

As used herein, “Workload” may refer to the overall amount of work to be handled or being received. In the example of a call center, workload may be work arriving at the call center. In other examples, e.g. where resources are computer hardware or software resources, workload may be measured differently. Workload may be calculated as a factor of volumes, average handling time, and customer latency, as well as others. Workload may be broken down into one or more skills, e.g. a workload may be given which is broken down or otherwise characterized by a workload for a first skill and a workload for a second skill.

As used herein, “Volume” may refer to a number of contacts coming into a contact center.

As used herein, “Interval” may refer to a unit of time, usually 15 minutes long in most contact centres for which planning in the contact centre is performed. Other intervals may be used, and embodiments may be used in contexts other than call centers.

As used herein, “Average Handling Time (AHT)” may refer to the average time from start to finish of a customer interaction. AHT may be an important factor in understanding how much work (e.g. workload) the contact center is handling/will handle.

As used herein, “Customer Latency” may refer to a measure describing how long on average a customer takes to respond to an agent after the agent has replied. This measure may be an important factor in quantifying the workload in the digital contact center.

As used herein, “Service Metrics” may refer to key performance indicators (KPIs) designed to evaluate the experience of the contacting customers and the quality of service provided to them, in terms of work force and agent availability. These KPIs can include average speed of answer, service level and customer latency amongst others. When the contact center is understaffed, service metrics may be lower than defined, and when over staffed, higher. Each user may select the service metrics that are important for their contact center and may define values based on their preferences. These may be referred to as “Service Targets” or “Required Service Metrics” in the sense that they are a required target to be achieved by any allocation assignment. Embodiments may distribute data streams or interactions, e.g. voice calls or chat streams, which in turn may result in the assignment of tasks or staffing.

As used herein, “Wait Time” or “Average Speed of Answer (ASA)” may refer to a service metric used for voice calls detailing how long customers waited until their call was picked up by an agent.

As used herein, “Service Level Agreement (SLA)” may refer to a service metric, similar to the above ASA. A service level agreement may allow a user to define a percentage of users answered within a selected time frame, e.g. 30 minutes. The more general “service level” or “level of service” may at times be used herein to refer to a quality of service as measured by one or more service metrics, which may include SLA.

As used herein, “Abandoned percentage” may refer to a service metric quantifying the possibility that as ASA grows, more customers get tired of waiting and hang up whilst waiting for an agent.

As used herein, “Skills” may refer to a method of compartmentalizing agent training and specialty into different useful categories, e.g. technical support, financial inquiries and so on. Skills may also be used as a means of representing different channels of communication such as voice, chat etc., where tech_support_voice could be one skill and tech_support_chat could be another.

As used herein, “Under/Over staffing” may refer to situations when the contact center is not working effectively, and money is being wasted. When overstaffed, customers are served beyond the defined service metrics, agents are not fully utilized, and money is wasted. When understaffed, customers are served poorly in terms of agent availability, and thus other important processes in the contact center cannot happen.

As used herein, “Forecasting Period” may refer to data generated for a selected period, often starting from the present or from the end time of the current schedule.

As used herein, “Concurrency” may refer to the fact that in the digital contact center agents serving customers over digital channels will often find themselves working on more than one contact at a time. Working concurrently on multiple contacts can both improve agent utilization as well as degrade the service provided to the contacting customer. Concurrency is often defined by the user creating the staffing requirements as a fixed value for the maximum amount of contacts an agent should work on.

As used herein, “Dynamic Concurrency” may refer to the phenomenon that as the workload, intensity and complexity of a specific work item varies, as well as the overall topics of customer requests changing, so too does the agent's ability to handle different levels of concurrency. The present approach presents a search over a machine learning model that evaluates these parameters and de facto returns an implicit concurrency level.

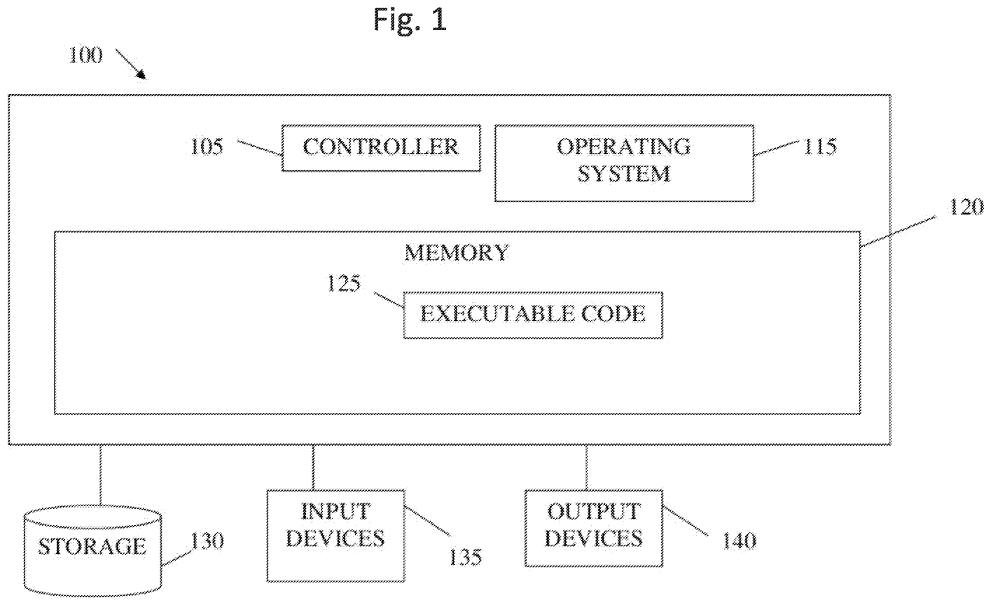

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task, or script. Executable code 125 may be executed by controller 105 possibly under control of operating system 115. For example, executable code 125 may be or execute one or more applications performing methods as disclosed herein, such as a machine learning model, or a process providing input to a machine learning model. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Embodiments of the invention may involve training a machine learning model. The machine learning model may be a deep learning model inspired by but differing from the structure of an organic human brain, otherwise known as a neural network. Where it is understood that deep learning models are a subset of machine learning models, further reference herein to machine learning should be understood as referring also to deep learning models.

A machine learning model may be trained according to some embodiments of the invention by receiving as input at least one of: volumes over different skills and channels; average handling time (AHT); customer latency; and number of agents assigned and corresponding skill composition. These data may represent historical data over past periods or intervals, where the data for each interval is a training sample. For each past interval the model may receive the actual workload (volumes, AHT, customer latency) as well as the available personnel. The output of the model may be the expected service metrics measured for this historical interval, such as service level, ASA, chat latency and/or general metrics for different channels. In an embodiment where the resource is another resource, for example a computer resource, the past interval training data may be loads or usage for computer resources.

Embodiments of the invention may train the machine learning model as essentially a regression model with multiple inputs and outputs. After the model is trained it may be utilized by a search algorithm.

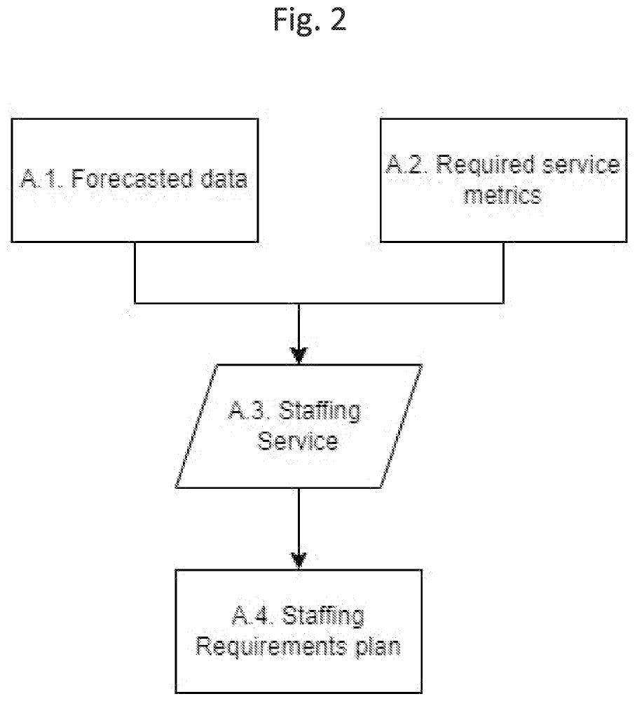

With reference to FIG. 2, embodiments of the invention provide a method for providing staffing schedules responsive to predicted requirements.

In the following diagrams, parallelograms represent processes, rectangles represent data and rhombuses represent decisions based on parameters and data. Parameters are represented as data as well.

Embodiments of the invention may include providing/receiving forecast data (block A.1). Forecasted data may take the shape of (|intervals|×|skills|×|features|), for example a vector or matrix with a number of entries/cells corresponding to a product between the number of intervals, skills and features. Forecasted data may be a time series depicting the workload relevant to the resource; e.g. the workload the call center will need to handle. This multi-variate time series may include features such as volume (number of contacts across different channels), AHT and average customer latency (average time elapsed between agent response and customer replying). The workload may be divided across different communications channels, and these communication channels may be non-voice communication channels (e.g. not a spoken telephone call) chosen, for example, from a list including any of: short message service, email, web chat, integrated chat, or social media message. Web chat and/or integrated chat may refer to a communication functionality coded into or otherwise available (e.g. as a widget) as part of a website or app, for example available on a customer service section of a company website. The forecasted data/workload may be broken down by or divided across one or more skills characterizing the resources, e.g. in a call/contact centre the workload may be broken down across agents having skills in refund requests, general queries, and customer complaints. The above features are examples and forecasted data is not limited to these or these alone. Features may be predicted for every interval during the forecasting period, and for each skill separately.

Embodiments of the invention may include providing/receiving at least one required staffing service metric value (block A.2). Required staffing service metrics may take the shape of (|skills|×|service metrics|). Required staffing service metrics may represent the minimal service level a user could accept. A user may set values for all variables. Possible metrics may include, for example, SLA (e.g., 80% of calls should be answered within 30 seconds) and chat latency (e.g., agents take 60 seconds to respond to a chat message on average).

Accordingly, a method and/or system according to embodiments of the invention may include as a first step receiving a forecasted workload and at least one required service metric value for each of the plurality of time intervals.

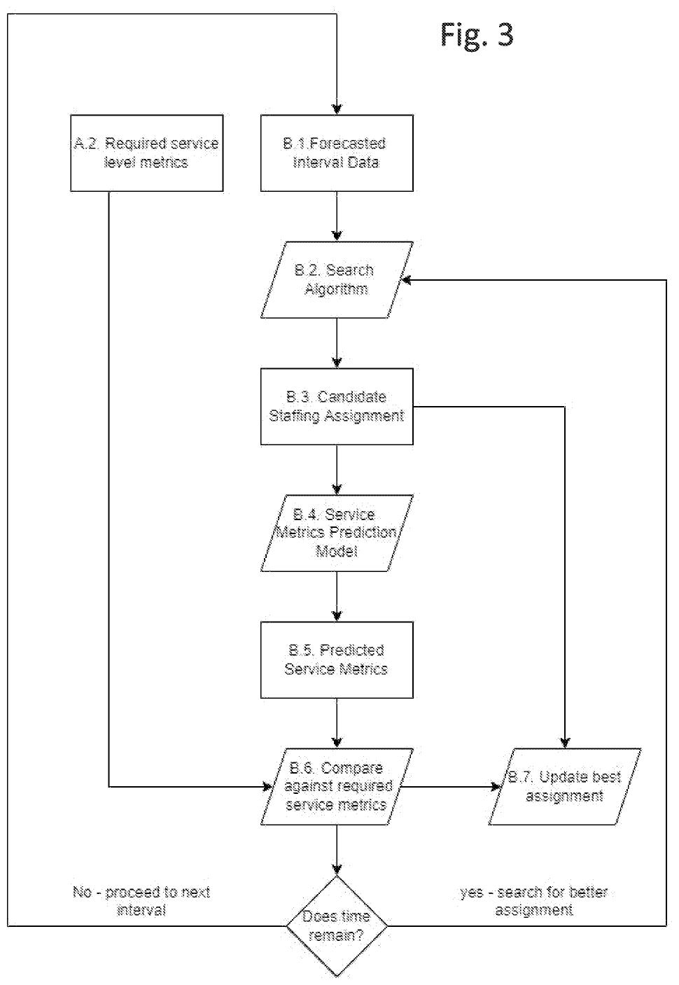

FIG. 3 represents a focused view of the staffing service and requirements plan (blocks A.3 and A.4) shown in FIG. 2, and describes an algorithm according to embodiments of the invention for creating staffing requirements for a single interval.

Forecasted interval data (block B.1) may take the shape (|skills|×|features|) and may represent a single time element from the forecasted data of A.1. Forecasted interval data is the workload that needs to be handled during a particular interval. For each interval, an iterative process may be performed, as will be described herein further below.

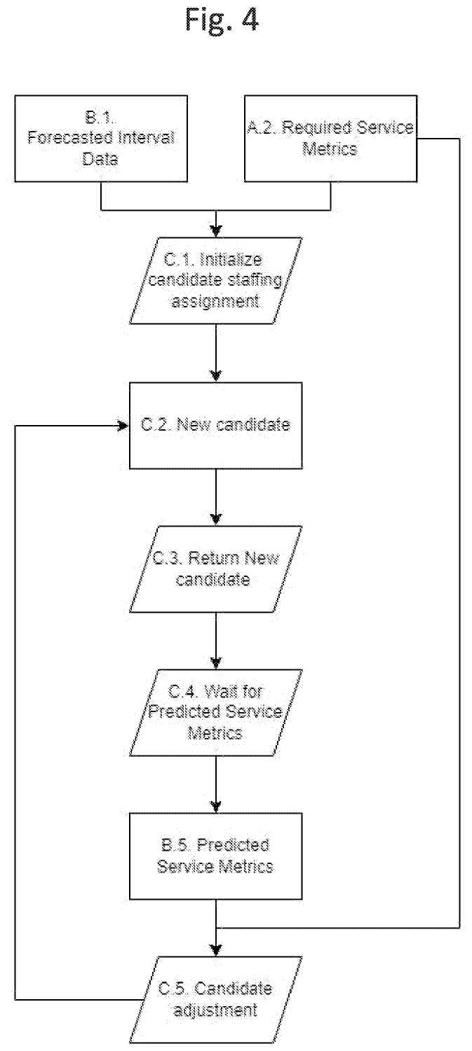

A search algorithm (block B.2) may suggest an initial/candidate staffing or assignment requirement (block B.3) for a specific interval: for example, a method and/or system according to embodiments of the invention may include, for each interval, applying a search algorithm to identify an initial allocation assignment. An example search algorithm is described in detail with respect to FIG. 4. The initial staffing/allocation assignment may have the shape (|skills|) and may represent a count vector of how many agents are suggested for each skill. A candidate staffing assignment, after one or more iterative updates as will be described further herein below, may become a single item/element in the time series of A.4 representing the full staffing requirements plan for all intervals. In other embodiments a search algorithm may be over assignments of other resources, such as computer resources.

A service metric value expected to be achieved by the initial staffing requirement (block B.3) handling the forecasted workload (block B.1) may then be predicted using a machine learning service level prediction model (block B.4), for example by inputting the initial allocation assignment to a machine learning algorithm, wherein the machine learning algorithm has been previously trained on historic data of a plurality of past intervals. Embodiments of the invention relate to a novel approach for using neural networks to predict the service metrics which may be provided in an interval by a certain staffing for a particular workload. Inputs to this model (e.g. the neural network) may include the forecasted workload (block B.1), and a (at least initial) staffing assignment (block B.3), and could be extended to include any other relevant input. For example, the model may receive as input a forecasted workload (e.g. a workload for future intervals, which may be broken down by skill) and a required service metric value. The machine learning model may provide a prediction: the output of this trained algorithm may be service metric predictions (e.g. a particular value) for each skill (block B.5). For example, a method and/or system according to embodiments of the invention may include predicting, for each at least one required service metric, by the machine learning algorithm, an expected service metric value provided by the initial allocation assignment.

Predicted service metrics (block B.5) as output by the service metrics prediction model (block B.4) (e.g. “expected” service metrics expected to be achieved by the assignment) may have the shape (|skills|×|service metrics|) and may represent predicted values for each service metric specified by a user. These values may represent the fit of the suggested staffing to the workload during the specific interval. For example, if the staffing assignment suggested as a candidate for the interval is insufficient to handle a certain workload, then the predicted values will be low.

The predicted service metric value(s) for the interval across all skills and service metrics as received by the machine learning service metrics prediction model may then be compared (block B.6) to the at least one required service metric value(s) (block A.2) as provided by the user. A difference between the required service metrics (block A.2) and the predicted service metrics (block B.5) may be calculated, for example by an element wise application of the subtraction operator (-). The result of this calculation may be a matrix of the same shape as in both blocks A.2 and B.5. Cells in the resulting matrix with a positive value may imply a specific skill is overstaffed. Cells with a negative value may imply a certain skill is under staffed. Cells with a value close to zero imply that the skill is staffed correctly. These values may be used to evaluate the staffing in each skill, as well as the overall fitness of the assignment.

After comparison, the candidate staffing requirement most fitting the required service metrics may be updated (block B.7), for example, by adjusting or modifying the initial allocation assignment based on a difference between the expected service metric value and the corresponding at least one required service metric value. If the current candidate staffing assignment is predicted to produce a better outcome (measured in terms of service metrics) than the previously suggested best candidate staffing assignment, then the best staffing assignment may be updated. Comparison may result in a scalar number representing how good a staffing assignment is. This scalar may be calculated as a weighted average of the difference/distance between the required and predicted service levels weighted by the volume of each skill, so the grade is consistent with the service level experienced by most users. The best candidate staffing assignment may be the assignment to supply the best service level at the lowest cost.

If time remains, the algorithm may iterate or repeat again, using the difference as expressed/captured by the correction factor between the required and the predicted service levels as a means of generating an improved candidate staffing assignment which, after several repetitions, may make the predicted service metrics converge to the required service level metrics. The optimal candidate for the interval may be set as the staffing requirements for this interval. If time does not remain, or if an optimal assignment (for example, within an acceptable predetermined distance range or ±tolerance of the required service level metrics) has been found for the interval, the algorithm may accept the candidate staffing requirement for the current interval and may proceed to the next interval. For example, the search algorithm may adjust an initial allocation assignment based on a difference between the expected service metric value and the corresponding at least one required service metric value and may iteratively repeat the previous applying, inputting, predicting, and adjusting operations until one of: the expected service metric value predicted for an adjusted allocation assignment is within a predetermined distance of the corresponding at least one required service metric value for the interval; or a predetermined time has elapsed. A predetermined distance may be a positive scalar value characterizing a “closeness” of the expected service metric value to the target service metric value. For example, a predetermined distance may be selected as within 0.3 of a required service metric value of 10, and thus an assignment which is predicted to achieve a corresponding service metric value of 6 is not within the predetermined distance (e.g. |10−6|=4>>0.3): however, an updated assignment which achieves a value of 10.2 for that assignment is within the predetermined distance (|10−10.2|=0.2<0.3).

A staffing requirements plan may be output (block A.4), which may have the shape (|intervals|×|skills|), and which may, for each interval, represent how many agents are needed in each skill. In other words, the staffing requirements plan is the sequence of interval requirements generated for all intervals within the forecasted period. The staffing requirements plan may be used to create a schedule of actual agents. For example, a method and/or system according to embodiments of the invention may include generating, from the iteratively adjusted allocation assignments, an allocation assignment plan for the plurality of time intervals.

FIG. 4 shows a focused view of the search algorithm shown in block B.2 of FIG. 3. The search algorithm may suggest the next candidate/potential staffing assignment based on the difference between the required service metrics and the predicted service metrics for the previous assignment. Using forecasted interval data (block B.1) and the required service metrics (block A.2) an initial staffing assignment may be generated (block C.1). A staffing assignment may have the shape (|skills|), and a positive entry in each cell may represent the number of agents required for the interval. A staffing assignment may also be referred to as a staffing option, or as an allocation assignment. In order to begin the search, the search algorithm may require a starting point, e.g. an initial staffing assignment. The initial staffing assignment could be generated by different methods, for example, random sampling, Erlang C formulas, simulations, etc. The initial staffing assignment may also be generated by a workload calculation by taking the total time needed (e.g. Volume*AHT) and dividing by the total time of one of the intervals: for example, for a volume of two calls that take 7.5 minutes each, the total is 2*7.5=15, then dividing by the length of a 15 minute interval, a workload of 1 agent may be obtained, e.g. 1 agent is required to handle the workload (given two calls of 15 minutes, or one call of 30 minutes, a workload of two agents is obtained). This initial staffing assignment, generated by any of the described means, may then be iteratively improved, as will be described herein.

The search algorithm may then enter a loop, and the new candidate (block C.2) may be returned (block C.3) to the calling procedure specified in FIG. 3. As with the initial staffing assignment, the new candidate may have the shape (|skills|), and a positive entry in each cell may represent the number of agents suggested for the interval. The newly suggested candidate staffing assignment is returned to the staffing service (A.3), shown in FIG. 3 as candidate staffing assignment (block B.3).

The search algorithm may now wait (block C.4) for the predicted service metric value(s) (block B.5) expected to be achieved for the staffing assignment. The search algorithm may receive either a stop signal on which the search will terminate, or the predicted service metric value(s) for the suggested/candidate assignment. The predicted/expected service metrics may have the shape (|skills|×|service metrics|). Predicted service metrics may be generated for each of the candidate staffing options suggested by the search algorithm and may be passed back to the search algorithm if time remains (see the bottom of FIG. 3).

Once received, the search algorithm may adjust the initial allocation assignment. For example, the search algorithm may use the predicted service metrics (block B.5) together with the required service metrics (block A.2) to calculate an adjustment factor and adjust (block C.5) the previous candidate. For example, a method and/or system according to embodiments of the invention may include adjusting, by the search algorithm, the initial allocation assignment based on a difference between the expected service metric value and the corresponding at least one required service metric value. The adjustment factor may be a vector and may have the shape (|skills|), and may represent how to adjust the staffing assignment to produce a candidate for the next iteration. Each cell in the adjustment vector may contain values used to increase (greater than 1) or decrease (between 0-1) the previous staffing assignment. The adjustment factor may result in the number of agents needed for a specific skill being increased if service metrics have not been met in a previous iteration, and decreased when service metrics have been exceeded (which may not be efficient or cost effective).

For each metric used to evaluate a skill, a ratio may be calculated. For metrics where a lower score is better, such as ASA (wait time until answer), an example correction ratio may be defined as follows:

$$correction ratio = \frac{( 1 + Predicted Metric Value )}{( 1 + Required Metric Value )}$$

wherein a predicted (service) metric value may also be referred to as an expected (service) metric value. Similarly, a required (service) metric value may also be referred to as a target (service) metric value.

For example, having an ASA value higher than required implies that the contact center is understaffed for this skill. The correction ratio in this case will be larger than 1. In the opposite case, the correction will be lower than one. The correction value may be calculated for each skill, where skills with more than one metric may average the correction ratio across service metrics. The resulting vector will have an entry for each skill with a value larger than 1 for skills where more agents are required, and a value between 0-1 if the number of agents in the skill should be reduced.

For metrics where a higher value is better, such as SLA, the correction ratio will simply be the inverse correction ratio, i.e. correction ratio⁻¹. Thus, a vector adjustment factor may include scalar correction ratios for each skill.

To calculate a new candidate for the next interval, an element-wise product may be performed between the previous candidate vector and the adjustment factor vector. The result of this product may be an increase or decrease in the suggested workforce, at the skill level, for the new candidate staffing assignment.

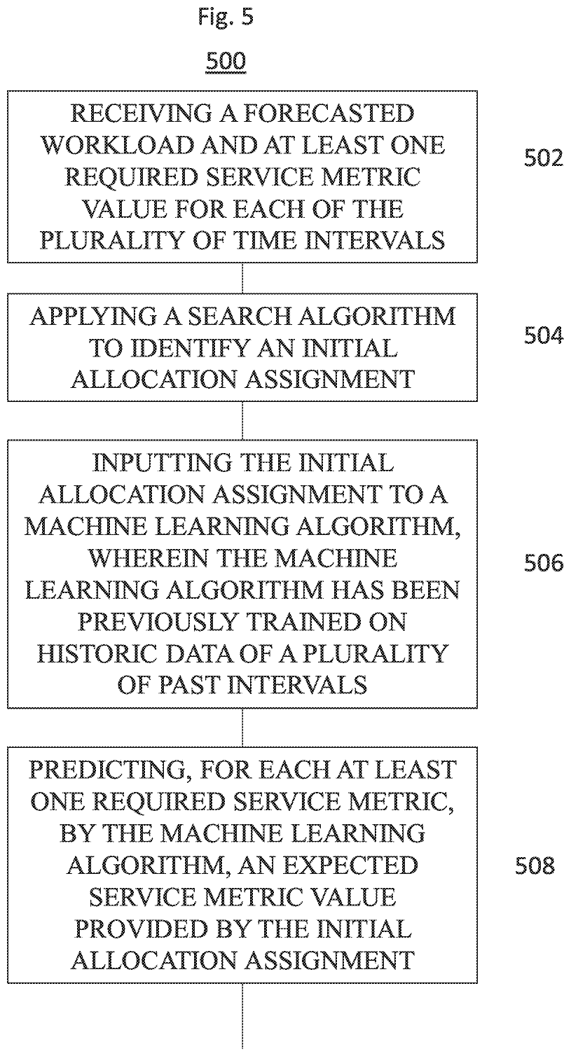

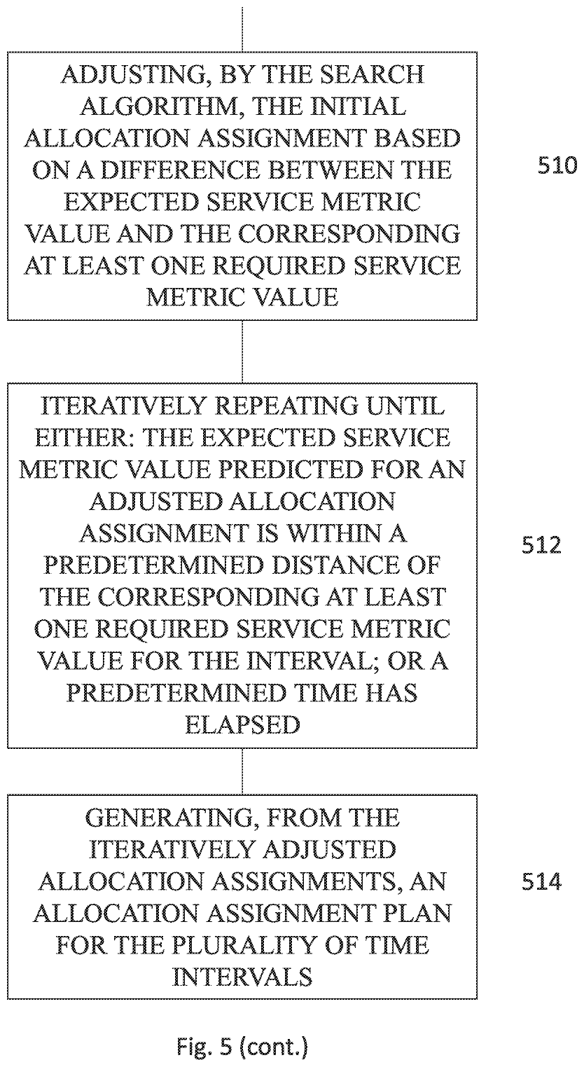

FIG. 5 shows a method 500 for allocating resources for a plurality of given time periods or intervals. While in one example embodiment resources may be workers such as contact center agents having desired skills, resources may also be any resource for which provisioning over a series of time intervals (next 20 minutes, next hour, next day, coming week, etc.) is required, for example: computer servers; data storage volumes; and power sources in a power grid. Resources may be classified by skills. For example, where the resources are workers such as agents in a contact center, skills may include technical expertise and financial expertise. Where the resource is a power source for example, the classifying skills (or attributes) may relate to a renewable status, a power output etc.

Method 500 may include receiving (502) a forecasted workload and at least one required service metric value for each of the plurality of time intervals. A forecasted workload may be forecasted by means known in the art, for example by simulation. A required service metric value may be a quantification of a level of service to be met based on one or more considerations such as demand, cost, and practicality.

Method 500 may include, for each period interval, applying (504) a search algorithm to identify an initial allocation assignment for that period or interval. The search algorithm may be a search algorithm as described by block B 0.2 and in FIG. 4, or another suitable search method. The initial allocation assignment may for example be a candidate staffing option. The initial allocation assignment may be selected based on random sampling, or may be a more informed selection based on Erlang C formulas, workload calculation, or simulation. In examples with other resources such as computer resources, allocation assignments may be relevant to assignment of those other resources.

Method 500 may include, for each interval, inputting (506) the initial allocation assignment to a machine learning algorithm. The machine learning algorithm may have been previously trained on historic data of a plurality of past intervals. The machine learning algorithm may be a service metrics prediction model as described by block B 0.4.

Method 500 may include, for each interval, predicting (508), for each at least one required service metric, by the machine learning algorithm, an expected service metric value provided by the initial allocation assignment. For example, based on training data of historic intervals, the machine learning algorithm may predict that an initial allocation assignment will achieve a particular value for a particular service metric.

Method 500 may include, for each interval, adjusting (510), by the search algorithm, the initial allocation assignment based on a difference between the expected service metric value and the corresponding at least one required service metric value.

Method 500 may include, for each interval, iteratively repeating (512) until for example the expected service metric value predicted for an adjusted allocation assignment is within a predetermined distance of the corresponding at least one required service metric value for the interval; or a predetermined time has elapsed or completed.

Method 500 may optionally include generating (514), from the iteratively adjusted allocation assignments, an allocation assignment plan for the plurality of time intervals. For example, a schedule or rota may be generated detailing how the resources are to be distributed across the intervals to achieve an optimal allocation for the forecasted workload.

An embodiment of the invention may also relate to a method for optimizing workforce management plans in environments concurrently handling a plurality of voice and non-voice communications channels for a plurality of workforce skills, in a given time interval. The method may include receiving a forecasted workload and a required level of service. A level of service may, for example, include one or more service metrics, and as such a level of service may include a required service level within the meaning of service level agreement (SLA), i.e. a predetermined percentage of customers answered in a predetermined time period. The method may include searching to identify an initial staffing assignment. The method may include predicting, by a machine learning algorithm, a predicted service level expected for the initial staffing assignment. The machine learning algorithm may have been previously trained on historic data of handling communications in past intervals. The method may further include calculating a difference between the predicted level of service and the required level of service. The method may further include iteratively updating the initial staffing assignment based on the calculated difference until either: the level of service predicted for the updated staffing assignment by the machine learning algorithm is within a predetermined distance of the required level of service for the interval; or a predetermined time has elapsed.

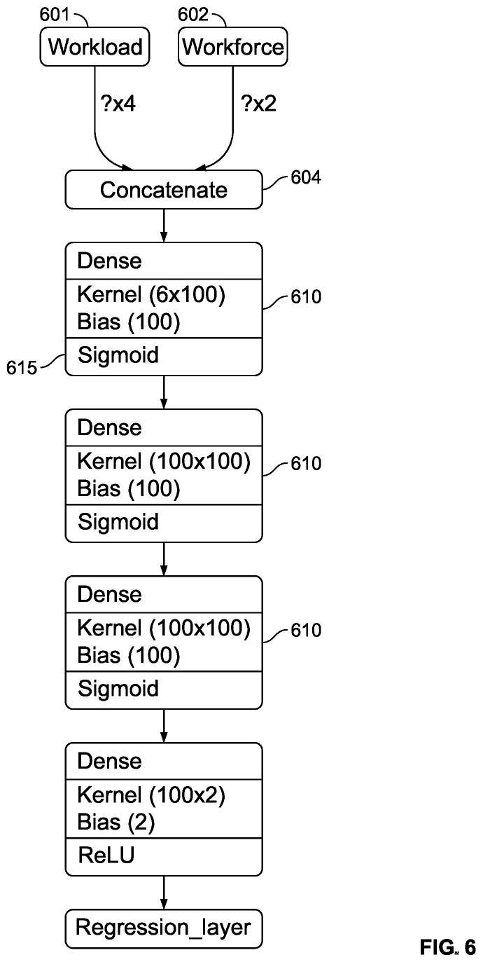

With reference now to FIG. 6, a machine learning algorithm employed by embodiments of the invention is discussed in detail. Embodiments of the invention suggest a novel method of predicting the service level using machine (or deep) learning predictors trained on historical data to produce accurate and personalized service metric predictions. According to embodiments of the invention, a model is trained to predict the service metrics in a particular interval based on the forecasted workload and the available agents, as well as other features that might include time of day, agent proficiency, and so on.

By analysing historical data intervals, three main elements may be calculated: Workload: the workload which came into the contact center during a specific interval. Actual staffing: The actual staffing is derived from the workforce working at the contact center at the time.

Service metrics: for each skill, depending on the channel, different service metrics are calculated. ASA for example would be calculated as the average time waited by customers on a voice skill until an agent answered the call.

Workload and actual staffing may serve as the main inputs to the machine learning model. The model may then be trained on historical intervals to predict the service metrics defined for each skill depending on the workload and the available personnel.

FIG. 6 describes an example machine learning model architecture 600, worked through for a two skill scenario. The model may have an input layer, which may receive the workload 601 and actual staffing (workforce) 602 for each skill, e.g. the expected volume, average handling time and number of agents for each skill. These inputs may be concatenated (604).

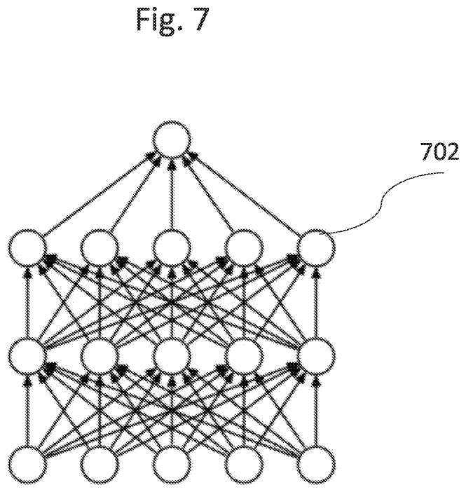

The input may be propagated through to a sequence of standard neural network dense layers 610, each followed by a sigmoid activation 615. Dense layers (also known as fully connected layers) are connected to each other, see FIG. 7. Activation functions may be used as switches determining the flow of information within the model. Activation functions may also be called non-linearities, as they allow stacked linear layers to model complicated non-linear problems. A sigmoid function is a bounded, differentiable, real function that is defined for all real input values and has a non-negative derivative at each point and exactly one inflection point. The function is common in deep learning architectures as it transforms all input values to values between 0 and 1. The sigmoid function is described by the expression:

$$S ( x ) = \frac{1}{1 + {e}^{- x}} = \frac{{e}^{x}}{{e}^{x} + 1}$$

The final layer may be a dense layer with a ReLU activation, trained to predict the service metric of each skill. The rectified linear unit (ReLU) activation function is a piecewise linear function that outputs the input directly if it is positive, otherwise it will output zero. It has become the default activation function for many types of neural networks because a model that uses it is easier to train and often achieves better performance. The ReLU activation function is defined as:

$$f ( x ) = \{ \begin{matrix}x & if x > 0 , \\ 0 & otherwise\end{matrix} .$$

The output of model 600 may be, for each skill, value predictions of the different service metrics, providing a predicted/expected service metric value(s) which can be leveraged by a search algorithm according to embodiments of the invention to identify an optimal staffing assignment.

As an example, for a certain past interval with two skills, a volume of 100 and 200 interactions (e.g. calls) for each skill respectively, an AHT of 240 and 180 seconds and a staffing of 10 agents and 100 agents respectively, the input vector may be [100, 200, 240, 180, 10, 100].

Given that for the first skill, 10 agents is far from enough agents to serve properly, it could be expected that the ASA metric will have a very high (e.g. bad) value. Since 100 agents is much more than needed for skill two, it could be expected that the ASA value will be very low. The output vector in this case could be [90, 8], meaning customers waited 90 seconds on average until being answered by an agent for skill 1, and 8 seconds for skill 2.

Below are example simulation results for a two skill scenario, using ASA as a service metric. All results are reported in pairs, one value for each skill. The algorithm is run on one time interval, and the output of the process will be the staffing requirements for this interval. In the scenario simulated below, the contact center will have to handle a volume of 100, 200 interactions (calls) for each skill respectively, and meet an average handling time (AHT) of 240, 180 seconds respectively. The initial candidate (block C.1, FIG. 4) can be seen on line 4 of the simulation printout. The initial candidate may be chosen by random sampling and allowed to converge by repeated iterations, or a more informed starting point can be chosen based on Erlang C formulas or simulation. Every iteration the model is used to generate a prediction of the service metric for each skill. Using the target and predicted metric value (ASA) for each skill, a correction factor is calculated for each skill, with the number of agents by which to increase or decrease each skill. A new candidate is created using the previous candidate and the adjustment factor. The candidate with predicted service metrics closest to the required service metrics will be used as the staffing requirement for this interval.

Table 1 below depicts example simulation results for a two skill scenario, using ASA as a service metric.

TABLE 1

Target service metric ASA: [30, 30]
Call volume: [100 200]
Call handling time (aht): [240 180]
Initial candidate: [24. 68.]
Iteration 0
Predicted service metric (ASA) : [46. 26.]
adjustment: [37.49 −7.57]
Candidate: [24. 68.]
New candidate: [61.49 60.43]
Iteration 5
Predicted service metric (ASA) : [25. 37.]
adjustment: [−1.09 11.03]
Candidate: [42.73 53.48]
New candidate: [41.64 64.51]
Iteration 10
Predicted service metric (ASA): [26. 27.]
adjustment: [−0.4 −0.57]
Candidate: [40.2 65.37]
New candidate: [39.8 64.8]
Iteration 15
Predicted service metric (ASA): [31. 28.]
adjustment: [2.5 −0.17]
Candidate: [37.64 67.49]
New candidate: [40.14 67.31]
Iteration 20
Predicted service metric (ASA): [31. 27.]
adjustment: [2.04 −0.23]
Candidate: [41.44 65.55]
New candidate: [43.48 65.32]
Iteration 25
Predicted service metric (ASA) : [29. 28.]
adjustment: [−0.04 −0.1]
Candidate: [44.38 63.67]
New candidate: [44.35 63.57]
Iteration 30
Predicted service metric (ASA) : [24. 25.]
adjustment: [−0.26 −0.3]
Candidate: [45.56 65.13]
New candidate: [45.3 64.83]
Iteration 35
Predicted service metric (ASA) : [25. 27.]
adjustment: [−0.17 −0.15]
Candidate: [44.01 63.59]
New candidate: [43.84 63.44]
Iteration 40
Predicted service metric (ASA): [27. 17.]
adjustment: [−0.09 −0.66]
Candidate: [43.1 64.75]
New candidate: [43.01 64.09]
Iteration 45
Predicted service metric (ASA) : [31. 20.]
adjustment: [0.99 −0.45]
Candidate: [43.46 63.19]
New candidate: [44.44 62.74]
Iteration 50
Predicted service metric (ASA) : [19. 25.]
adjustment: [−0.29 −0.17]
Candidate: [43.74 63.7]
New candidate: [43.45 63.53]
Iteration 55
Predicted service metric (ASA) : [28. 26.]
adjustment: [−0.05 −0.14]
Candidate: [42.8 63.04]
New candidate: [42.75 62.91]
Iteration 60
Predicted service metric (ASA): [21. 25.]
adjustment: [−0.21 −0.15]
Candidate: [43.29 63.54]
New candidate: [43.08 63.39]

FIG. 7 shows an example of a neural network architecture, as may be used by embodiments of the invention. Individual neurons or nodes 702 may be connected to other neurons, and neurons may be organized into layers.

The following Table 2 summarizes example data used by embodiments of the invention.

TABLE 2

| Block | Shape | Description |
|---|---|---|
| A.1 Forecasted | (lintervals\| × \|skills\| × \|features\|) | Time series depicting the workload the call |
| Data | | center will need to handle. This multi-variate |
| | | time series may include features such as |
| | | volume (number of contacts across different |
| | | channels), AHT, and average customer |
| | | latency. |
| A.2 Required | (\|skills\| × \|service metrics\|) | The minimal service level a user could accept. |
| staffing metrics | | User sets values for all variables. Possible |
| | | metrics may include SLA (e.g., 80% of calls |
| | | should be answered within 30 seconds) and |
| | | chat latency (e.g., 80% of chat messages |
| | | responded to within 60 seconds). |
| A.4 Staffing | (\|intervals\| × \|skills\|) | For each interval, how many agents are needed |
| Requirements | | in each skill. The staffing requirements plan |
| Plan | | will be used to create a schedule of actual |
| | | agents. |
| B.1 Forecasted | (\|skills\| × \|features\|) | A single time element from A.1. Forecasted |
| Interval Data | | data. This is the workload that needs to be |
| | | handled during the interval. |
| B.3 Candidate | (\|skills\|) | A count vector of how many agents are |
| Staffing | | suggested for each skill. Might become a |
| Assignment | | single time element from A.4. |
| B.5 Predicted | (\|skills\| × \|service metrics\|). | Outputs of B.4. Predicted values for each |
| Service Metrics | | service metric specified by user. |
| C.2 New | (\|skills\|) | A vector with positive entries in each cell |
| Candidate | | representing the number of agents suggested in |
| | | the candidate staffing for the interval. |
| C.5 Candidate | (\|skills\|) | A new candidate with increased personnel at |
| Adjustment | | skills that were understaffed and decreased |
| | | personnel for skills that were overstaffed. |

Embodiments of the invention may take the output of an algorithm (e.g. staffing requirements for each skill for interval in the given period) and may use this output as an input for a scheduling system, which may assign specific agents for the shift. Embodiments of the invention may perform this action automatically, without human intervention.

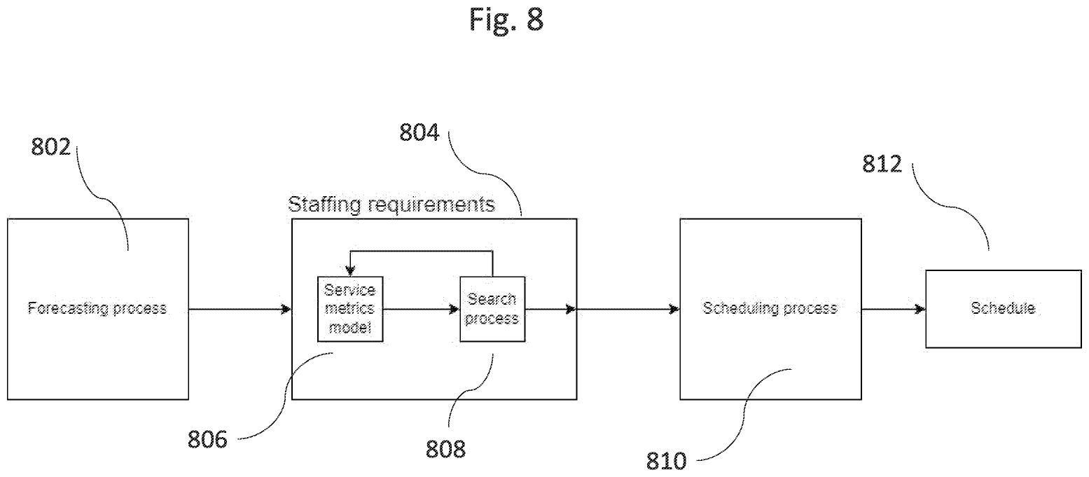

FIG. 8 demonstrates how a model according to embodiments of the invention is a working element of a wider process for creating staffing requirements. For example, a forecasting process 802, as may be known in the art, may generate forecasted data such as an expected workload for a given interval. Staffing requirements 804 may then be generated in accordance with embodiments of the present invention, for example by a trained service metrics model 806 (such as a machine learning model herein described) operating in iterative conjunction with a search process 808 (such as a search algorithm herein described). Generated staffing requirements may then be passed to a scheduling process 810, which may automatically produce a schedule 812.

Further, embodiments of the invention may be used to identify gaps in staffing as and when they are generated. Gaps in staffing may be due to unplanned events during the day, and embodiments of the invention may suggest proactive actions such as postponing a break, canceling training, etc.

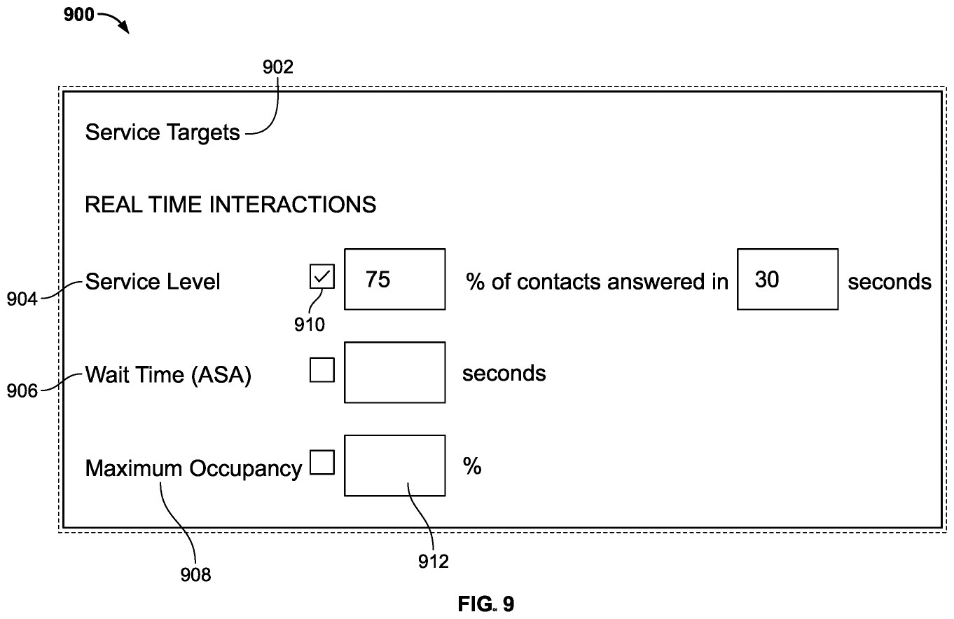

FIG. 9 shows an example of a graphic user interface (GUI) 900 according to embodiments of the invention. Service Targets 902 may refer to a KPI designed to evaluate the experience of the contacting customers and the quality of service provided to them, in terms of work force and agent availability. Service level (SLA) 904, a common service metric, may allow the user to define the percentage of users answered within a selected time frame, e.g. 80% of customers answered within 20 minutes. Wait Time 906 (ASA) is a common service metric used for voice calls detailing how long customers waited until their call was picked up by an agent. Maximum Occupancy 908 may refer to a value meant to specify how far off the contact center should be from working at its full capacity. Using an interface 900 such as that shown by FIG. 9, a user may be able to set the desired target service metric values. User interface 900 may include checkboxes 910, which may allow a user to toggle or otherwise select which service metrics they wish to optimize. User interface 900 may include input fields 912, which may allow a user to enter a value (e.g. a numeric value) representing the desired service metric. User interface 900 may allow a user to change a duration of a time period, for example an interval, or a timeframe with respect to SLA. User interface 900 may include dropdowns or fields with which to change a time period, for example a dropdown list expressing units of seconds, minutes, hours, etc.

A system according to embodiments of the invention may take inputs from GUI 900 and conduct a search over the predictions of the neural network to find an optimal staffing candidate.

Embodiments of the invention may improve the technologies of computer automation, big data analysis, and computer use and automation analysis by using specific algorithms to analyze large pools of data, a task which is impossible, in a practical sense, for a person to carry out. Embodiments of the invention may improve existing scheduling technologies by rapidly and automatically analysing previously unutilized pools of historic data. Integration of embodiments of the invention into a contact centre environment may improve automated call-dialing technology. Embodiments of the invention may improve the technology of “smart” chats, which use contextual word recognition to automatically reply to client queries.

As described, as digital communication channels become more common, agents may be required to handle more than a single contact at a given time. This setting contradicts many of the basic paradigms the engineers of historical contact centers had in mind when they designed such contact centers. Multiple existing concepts and processes are disrupted by these new flows introduced by concurrent assignment of contacts to the same agent.

Simulations are a common tool used for generating staffing requirements and are one of these processes that are disrupted. The basic assumption regarding independence of different contacts/interactions with regards to other contacts/interactions, may be disrupted. As a call is assigned to an agent within the simulation, or in advance, a duration is drawn from a random distribution and set for the contact. For voice contacts it is customary that an agent is fully occupied by one contact and will remain so for the duration of the contact. For digital contacts such as chats, an agent may handle a varying number of contacts, e.g., 3, and will only be available for assignment once the number of items that are assigned to the agent (the agent's concurrency) goes lower than a maximum defined concurrency.

One shift with potential implications is the impact concurrent assignments have not only on the agent handling them, but also on the other contacts that the agent is handling concurrently. Customers may not realize that an agent is handling multiple interactions and may view their interaction as independent from other contacts, despite multiple interactions being handled by an agent at once, which may affect agent availability, response time latency, resolution time and so on. This may negatively impact the customer experience. The agent as well may be impacted by the assignment of multiple concurrent contacts. As concurrency increases, the agent is required to switch between multiple concurrent contacts. This context switch can be expensive in terms of psychological cost and can have a strong impact on the agent in terms of fatigue, focus, temper and general satisfaction.

The duration that was randomly selected during assignment does not and cannot account for the impact concurrent assignments to the same agent will have on the contact. For example, for a chat that was assigned to an agent who was not preoccupied with other chats, this chat may have an expected duration of 5 minutes. However, as two more chats are assigned to the agent, a substantial decrease in the agent's availability with regards to the first chats can be expected, the waiting time experienced by the customer of the first chat increases, and finally, the total duration of the first chat exceeds 5 minutes.

There is a need for systems and methods to model the impact of concurrent assignment and empower the different services in the contact center to take into account the impact of assignment and make more accurate decisions and predictions, both for planning (staffing, scheduling, distributing data streams or interactions) as well as routing, intraday management, personalized agent configuration and so on. Embodiments of the invention may thus improve the technology of routing interactions (e.g. chat data, or other data streams) among user terminals, such as agent terminals; and the technology of modeling such routing and streaming.

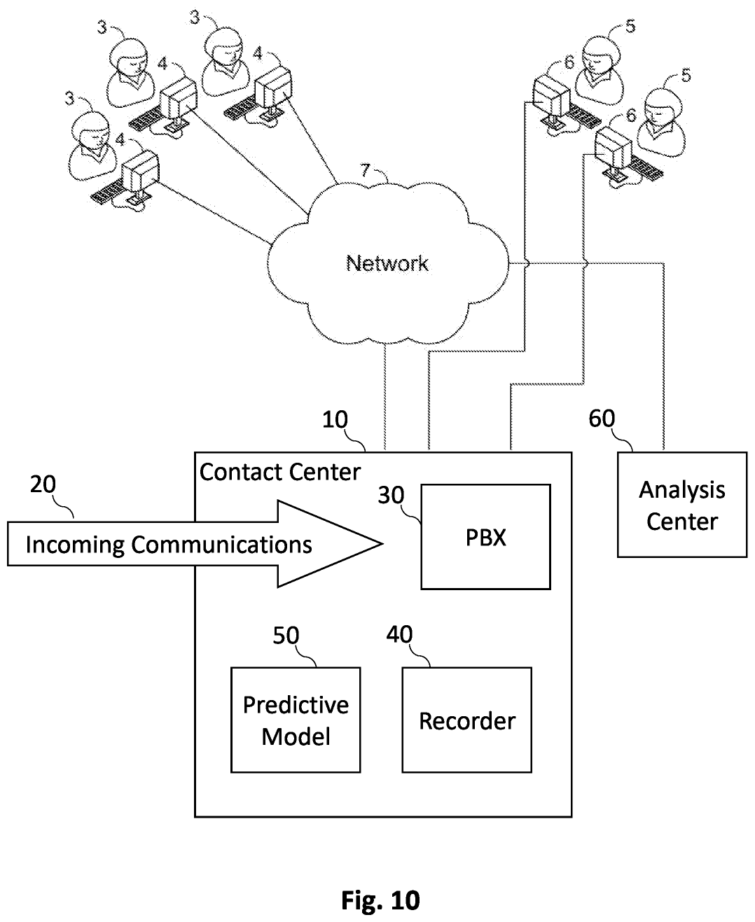

FIG. 10 is a block diagram of a system for processing data streams or interactions, according to some embodiments of the invention. While FIG. 10 shows a system processing communications or sessions at a contact center, data streams can be created in other ways. While examples are given in the context of agents and communications, embodiments of the invention may be used in the context of other environments, such as processing data streams by computing devices in a network. While interactions and data streams describing communications are described herein, in other embodiments work product other than communications may be processed.

Incoming communications/interactions 20 (e.g., telephone calls, emails, web chat, interactive voice response (IVR) interactions, etc.) among people 3 and agents 5 may enter a contact center 10 and be routed for example by a PBX (private branch exchange) 25 or other equipment to relevant systems, such as recorder 40. People 3 may operate user equipment 4 (e.g., a smartphone) to communicate with agents 5 via contact center 10; and agents 5 may operate agent terminals 6 for that communication and other purposes.

Contact center 10 may be for example maintained or operated by a company (e.g., a bank, a store, an online retailer, etc.), government or other organization. Communication data may be stored, e.g., in files and/or databases: for example recorder 40 may record information related to communications, such as the content or substance of interactions (e.g. recordings and/or transcripts of telephone calls, chat sessions, and/or email etc.), metadata (e.g. telephone numbers used, customer identification (ID), etc.), and quality metrics. The data from contact center 10 may be output, sent or exported to an analysis center 60, typically periodically, e.g. once a day. Analysis center 60 may be part of contact center 10, or external to and/or remotely located from contact center 10. The transfer may be via for example SFTP (Secure File Transfer Protocol) but may be via other methods.

One or more networks 7 may connect equipment or entities not physically co-located, for example connecting user equipment 4 to contact center 10, and contact center 10 to analysis center 50. Networks 7 may include for example telephone networks, the Internet, or other networks. While in FIG. 10 contact center 10 is shown passing data to analysis center 50, these entities may communicate via a network such as networks 7.

It may be appreciated that contact center 10 presented in FIG. 10 is not limiting and may include any blocks and infrastructure needed to handle voice, text (SMS (short message service), WhatsApp messages, chats, etc.) video and any other type of interaction with customers.

User equipment 5 and agent terminals 6 may include computing or telecommunications devices such as personal computers or other desktop computers, conventional telephones, cellular telephones, portable or tablet computers, smart or dumb terminals, etc., and may include some or all of the components (such as a processor/controller) shown in FIG. 1.

Prediction model 50 may receive data sequences characterising incoming communications/interactions, and may predict increases in duration for handling multiple communications concurrently. The prediction model may include for example a machine learning algorithm, a regression algorithm, a deep learning algorithm, a neural network, a long term short memory neural network, a fully connected neural network, and/or a convolutional neural network, or any combination thereof.

The data exported to analysis center 60 may be formatted, extracted and/or normalized to be data that represents features of communications, such as quality metrics characterising attributes of the communication. Data may be stored in various formats, such as one tuple, representing a communication session, per row, or other formats. Communications/interactions may include or be associated with other data, such as metadata describing the customer identification, channel identification (e.g., telephone number), start and/or stop time, duration in time of the interaction, number of other communications also handled by an agent during the same period, or other data. While the creation or extraction of data from various interactions may be performed by contact center 10, such data may be created or extracted by another entity such as analysis center 60. In other embodiments, interactions may be represented with other or more information. For example, an interaction may be a vector of features based on the actual interaction such as the start time, end time, customer ID, channel, contact reason, etc.

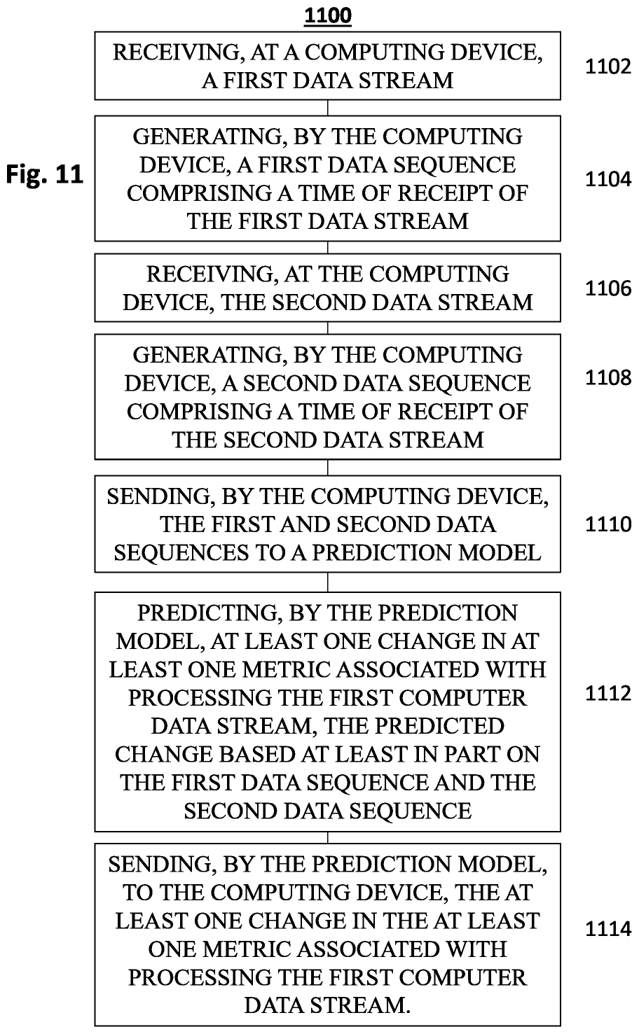

FIG. 11 is a flowchart of a computer implemented method 1100 for, upon receipt of a second data stream, predicting a change in processing a first data stream, according to some embodiments of the invention. In some embodiments, the first and second data streams represent communications/interactions being handled in a contact centre (e.g., incoming communications to the contact centre). In some embodiments, the change in processing the first data stream relates to a change in a duration to process the first data stream upon receipt of a second

Method 1100 may include receiving, at a computing device, the first data stream (Step 1102). The computing device may be an agent terminal 6 as described in FIG. 10, and may be or may include elements of a computing device 100 described in FIG. 1.

Method 1100 may include generating, by the computing device, a first data sequence comprising a time of receipt of the first data stream (Step 1104). For example, the time of receipt may be a timestamp recorded by the computing device upon receiving the first data stream. The time of receipt may be an elapsed time since the start of an agent session, for example a number of hours, minutes, and/or seconds elapsed since an initial time zero of the computing device starting an active session.

Method 1100 may include receiving, at the computing device, the second data stream (Step 1106). In some embodiments, the second data stream is received whilst handling of the first data stream is still in progress, for example a second incoming web chat whilst an agent is already handling a first web chat.

Method 1100 may include generating, by the computing device, a second data sequence comprising a time of receipt of the second data stream (Step 1108). A data sequence may be data describing a sequence of events from the computing device's point of view and/or the agent's point of view (e.g. agent 5 operating agent terminal 6 shown in FIG. 10). For example, the time of receipt may be a timestamp recorded by the computing device upon receiving the second data stream. The time of receipt may be later than the time of receipt of the first data stream. The time of receipt may be an elapsed time since the start of an agent session, for example a number of hours, minutes, and/or seconds elapsed since an initial time zero of the computing device starting an active session. The time of receipt may be an elapsed time since the time of receipt of the first data stream, for example a number of hours, minutes, and/or seconds elapsed since an initial time zero of the computing device receiving the first data stream.

Method 1100 may include sending, by the computing device, the first and second data sequences to a prediction model (Step 1110). The first and second data sequences may be sent together in a single communication. In some embodiments, the first and second data sequences are sent substantially in parallel or concurrently, for example within a bounded time period of one another such as 5 seconds or less.

In some embodiments, the prediction model includes a machine learning algorithm. In some embodiments the machine learning algorithm includes one of: a regression algorithm; a deep learning algorithm; a neural network; a long term short memory neural network; a fully connected neural network; and/or a convolutional neural network, or any combination thereof. Embodiments of the invention are not limited to only these example algorithms described, and other algorithms for machine learning may be used. The prediction model may include a trainable algorithm that receives the data sequences

Method 1100 may include predicting, by the prediction model, at least one change in at least one metric associated with processing the first data stream (Step 1112). The prediction may be based at least in part on the first data sequence and/or the second data sequence. A metric or measure associated with processing the first data stream may be, for example, a duration (e.g. a total time to complete processing), a required memory space, an input output operations per second (IOPS) measurement, a download rate (e.g. in bits per second, bytes per second, or any other suitable units), an upload rate (e.g. in bits per second, bytes per second, or any other suitable units), a frame rate (e.g. in frames per second (FPS)), a data compression ratio, or any other type of metric associated with processing a data stream. In some embodiments, for example embodiments where the data streams represent communications being handled in a contact center, the at least one metric associated with processing the first data stream may be a service/quality metric. For example, the at least one metric may be associated with a change in duration (which may affect average handling time (AHT), for example), a change in agent sentiment, a change in customer sentiment, a change in service level agreement, a change in average speed of answer (ASA), or any other type of metric associated with handling communications in a contact center.

Method 1100 may include sending, by the prediction model, to the computing device, the at least one change in the at least one metric associated with processing the first computer data stream. (Step 1114). The computing device may use the change in the at least one metric as part of automated decisions.

In some embodiments, the at least one metric associated with processing the first computer data stream includes a duration for processing the first computer data stream. The prediction model may predict a change in a first duration for the computing device to process the first computer data stream, the predicted change based on the first data sequence, the second data sequence, and a second duration for the computing device to process the second computer data stream.

A duration of the first and/or second data stream may be a randomly assigned duration in accordance with principles known in the art. The duration of the first data stream may be assigned before receipt of the second data stream, for example as part of generating a first data sequence for the first data stream (Step 1104). The duration may be included as part of the data sequence. For example, an end time drawn from a random distribution may be assigned by the computing device to the first data stream and sent with the time of receipt to the prediction model. Since the end time corresponds to the duration of a call, a Normal distribution with the mean and variance calculated for historical durations may be used. In some embodiments, the prediction model may assign a duration, random or otherwise, to a data stream as part of processing a data sequence for that data stream.

In some embodiments, the duration is a non-random duration assigned based on a simulation or other prediction which uses historic data of past data sequences to estimate a likely (e.g., probable) duration for processing/handling the data stream. For example, based on a subject header of an incoming communication such as an email, a duration may be assigned which is an average (e.g., mean) of actual durations for handling historic communications with the same or similar header. Historic AHT data may be used for this purpose.

According to some embodiments, a change in the first duration is an increase in an initially assigned duration. For example, if an initially assigned duration for the first data stream was 5 minutes, the prediction model may predict an increase in duration of 6 minutes (e.g., a total time to process of 11 minutes) for processing the data stream due to the requirement for now concurrent processing of the received second data stream. The prediction may be based on one or more of the first data sequence (which may include the initial duration), the second data sequence, and/or a second duration of the second data stream.

In some embodiments, method 1100 includes deciding, by the computing device, on the basis of the at least one change in the at least one measure or metric associated with processing the first computer data stream, whether to process the second data stream or to send the second data stream to be processed by a different computing device. For example, a change in a duration taken to process the first data stream may be of such an extent to make processing of the second data stream alongside processing of the first data stream unfeasible, and so the second data stream may be directed to a different computing device for processing.

The decision by the computing device whether to process the second computer data stream concurrently with the first computer data stream, or to send the second computer data stream to be processed by a different computing device may be evaluated with respect to one or more predefined rules. A predefined rule may be data describing a logical series of events, and may include one or more thresholds.

For example, a rule may be predefined that has the effect that if a predicted change in required memory is greater than a total available memory then the computing device does not process the second computer data stream concurrently with the first computer data stream, and instead sends the second computer data stream to be processed by a different computing device.

As another example, a rule may be predefined that has the effect that if a predicted change in ASA is greater than a predefined threshold value (such as 1 minute, for example) then the computing device does not process the second data stream concurrently with the first computer data stream, and instead sends the second computer data stream to be processed by a different computing device.

As another example, a rule may be predefined that has the effect that if a predicted change in duration is less than a predefined threshold value (such as 10 minutes, for example) then the computing device will process the second computer data stream concurrently with the first computer data stream.

In some embodiments, method 1100 may include predicting, by the prediction model, a change in at least one metric associated with processing the second computer data stream upon initiating processing of the second computer data stream concurrently with processing the first computer data stream, the predicted change based at least in part on the first data sequence and/or the second data sequence. For example, a change in duration (e.g., an initially assigned duration) for both the first and second data streams may be predicted, which may indicate how concurrent processing of both data streams affects the processing time of each data stream. In some embodiments, this may improve service metric predictions and/or scheduling of agents due to more accurate predictions of agent availability and/or AHT.

It should be noted that method 1100 may be extended to any number of interactions or data streams already being concurrently processed by the computing device. For example, in some embodiments, the first computer data stream represents a plurality of computer data streams being processed by the computing device, the method steps repeated for each computer data stream of the plurality of computer data streams.

For example, a computer implemented method for predicting a change in processing (n−1) data streams upon receipt of an nth data stream, wherein n>2, may include: receiving, at the computing device, the first (n−1) data streams; generating, by the computing device, a first (n−1) data sequences comprising a time of receipt of each of the first (n−1) data streams; receiving, at the computing device, the nth data stream; generating, by the computing device, an nth data sequence comprising a time of receipt of the nth data stream; sending, by the computing device, the n data streams to the prediction model; predicting, by the prediction model, at least one change in at least one metric associated with processing the first (n−1) data streams based at least in part on at least one of the first (n−1) data sequences and/or the nth data sequence; and sending, by the prediction model, to the computing device, the at least one the at least one change in the at least one metric associated with processing the first (n−1) data sequences.

In some embodiments, deciding, by the computing device, whether to process the second data stream or send the second data stream to be processed by the different computing device, is further based on a predefined concurrency threshold. The predefined concurrency threshold may be, for example, an integer value chosen depending on the concurrent processing power of the computing device. For example, the computing device may have a predefined concurrency threshold set by an administrator, which may dictate that the computing device is only to handle concurrent processing of, e.g., 10 or less data streams. An incoming 11^{th} data stream may be sent to be processed by a different computing device in such an example.

In some embodiments, the concurrency threshold may be set depending on a level of focus, attention, or ability to multi-task of an agent operating the computing device. For example, for a particular agent operating a computer device it may be determined that the agent is capable of handling up to 5 communications concurrently. An incoming 6th communication may be sent to be processed by a different agent operating a different computing device in such an example. The concurrency threshold may be based on other factors such as quality metrics. For example, it may be found that when an agent concurrently handles more than 5 communications, the quality of all communications (such as measured by one or more quality metrics such as ASA, SLA, customer sentiment etc.) being handled may decrease, e.g. because the agent is distracted trying to answer all customers and therefore takes longer to reply to any one particular customer.

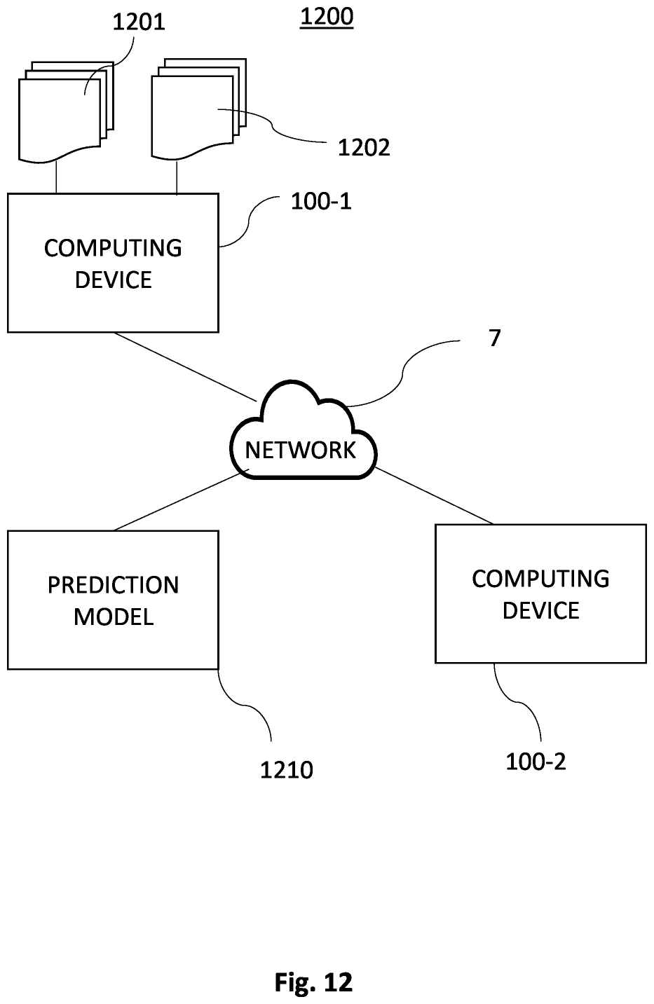

FIG. 12 is a schematic drawing of a system 1200 for predicting a change in processing a first computer data stream 1201 upon receipt of a second computer data stream 1202, according to some embodiments of the invention. In some embodiments, the first and second data streams represent communications being handled in a contact center.

System 1200 may include a computing device 100-1. Computing device 100-1 may be a computing device such as computing device 100 shown in FIG. 1. Computing device 100-1 may be connected to a network 7, which may be a network as described above with respect to FIG. 10. In some embodiments, connection to network 7 may be a wired connection (e.g. ethernet). In some embodiments, connection to network 7 is a wireless connection (e.g. WiFi)

Computing device 100-1 may be configured to receive the first computer data stream 1201. In some embodiments, the first computer data stream represents a plurality of computer data streams to be/being processed by computing device 100-1, for example a number (n−1) of computer data streams, where n is an integer greater than 2.

Computing device 100-1 may be configured to generate a first data sequence. The first data sequence may include a time of receipt of the first data stream 1201. In embodiments where the first computer data stream represents a plurality of (n−1) computer data streams, computing device 100-1 may generate a data sequence for each of the plurality of (n−1) computer data streams, each data sequence including a time of receipt of the respective computer data stream.

Computing device 100-1 may be configured to receive the second data stream 1202. In some embodiments, the second computer data stream 1202 represents a plurality of computer data streams to be processed by computing device 100-1, for example a number m of computer data streams, where m is an integer greater than 1.

Computing device 100-1 may be configured to generate a second data sequence. The second data sequence may include a time of receipt of the second data stream 1202. In embodiments where the first computer data stream represents a plurality of m computer data streams, computing device 100-1 may generate a data sequence for each of the plurality of m computer data streams, each data sequence including a time of receipt of the respective computer data stream.

Computing device 100-1 may be configured to send the first and second data sequences to a prediction model 1210. Prediction model 1210 may be connected to the same network 7 as computing device 100-1 (e.g. prediction model 1210 is located on and/or executed by a computing device connected to network 7), and computing device 100-1 may send the first and second data streams over network 7. The first and second data sequences may be sent together in a single communication. In some embodiments, the first and second data sequences are sent substantially in parallel, for example within a bounded time period of one another such as 5 seconds or less.

Prediction model 1210 may be configured to receive the first and second data sequences from computing device 100-1. In some embodiments, prediction model 1210 is located on and/or executed by computing device 100-1. In some embodiments, prediction model 1210 may be located on and/or executed by a computing device other than computing device 100-1, such as a central server (not shown) connected to network 7.

Prediction model 1210 may be a prediction model as described above with reference to method 1100 of FIG. 11. For example, in some embodiments, prediction model 1210 includes a machine learning algorithm. In some embodiments the machine learning algorithm includes one of: a regression algorithm; a deep learning algorithm; a neural network; a long term short memory neural network; a fully connected neural network; and/or a convolutional neural network, or any combination thereof. Embodiments of the invention are not limited to only these example algorithms and prediction models described, and other algorithms/models for machine learning may be used.

Prediction model 1210 may be configured to predict at least one change in at least one metric associated with processing the first computer data stream. The predicted change may be based at least in part on the first data sequence and/or the second data sequence. As described above, a metric associated with processing the first data stream may be, for example, a duration (e.g. a total time to complete processing), a required memory space, an input output operations per second (IOPS) measurement, a download rate (e.g. in bits per second, bytes per second, or any other suitable units), an upload rate (e.g. in bits per second, bytes per second, or any other suitable units), a frame rate (e.g. in frames per second (FPS)), a data compression ratio, or any other type of metric associated with processing a data stream. In some embodiments, for example embodiments where the data streams represent communications being handled in a contact center, the at least one metric associated with processing the first data stream may be a service/quality metric. For example, the at least one metric may be associated with a change in duration (which may affect AHT, for example), a change in agent sentiment, a change in customer sentiment, a change in service level agreement, a change in average speed of answer (ASA), or any other type of metric associated with handling communications in a contact center.

Prediction model 1210 may be configured to send, to computing device 100-1, the at least one change in the at least one metric associated with processing the first computer data stream 1201. Prediction model 1210 may send the at least one change over network 7.

Computing device 100-1 may be configured to receive, from prediction model 1210, the at least one change in the at least one metric associated with processing the first computer data stream 1201. Computing device 100-1 may receive the at least one change over network 7. In embodiments where prediction model 1210 is located on and/or executed by computing device 100-1, computing device 100-1 may retrieve the at least one change from memory and/or storage, such as memory 120 and/or storage 130 shown in FIG. 1

Computing device 100-1 may be configured to decide, on the basis of the at least one change in the at least one metric associated with processing the first computer data stream 1201, whether to process the second computer data stream 1202 concurrently with the first computer data stream 1201, or to send the second computer data stream 1202 to be processed by a different computing device 100-2. The different computing device 100-2 may be a computing device 100 as shown in FIG. 1. Computing device 100-2 may be a similar computing device to computing device 100-1, and my, for example, be operated by a same organization as computing device 100-1. For example, in embodiments where the data streams represent communications being handled in a contact centre, computing devices 100-1 and 100-2 may be agent terminals 6 for the receipt of incoming communications 20 as described with respect to FIG. 10. Computing device 100-2 may be connected to the same network 7 as computing device 100-1 and/or prediction model 1210.

The decision by computing device 100-1 whether to process the second computer data stream 1202 concurrently with the first computer data stream 1201, or to send the second computer data stream 1202 to be processed by computing device 100-2 may be evaluated with respect to one or more predefined rules. As described, a predefined rule may be data describing a logical series of events, and may include one or more thresholds.

For example, a rule may be predefined that has the effect that if a predicted change in download rate reduces the download rate below a predefined threshold (such as 100 kB/s, for example) then computing device 100-1 does not process the second computer data stream 1202 concurrently with the first computer data stream 1201, and instead sends the second computer data stream 1202 to be processed by a different computing device such as computing device 100-2.

As another example, a rule may be predefined that has the effect that if a predicted change in duration is greater than a predefined threshold value (such as 10 minutes, for example) then computing device 100-1 will not process the second computer data stream concurrently with the first computer data stream 1201 and will instead send the second computer data stream 1202 to be processed by a different computing device such as computing device 100-2.

In some embodiments, computing device 100-1 is further configured to decide whether to process the second computer data stream 1202 concurrently with the first computer data stream 1201, or send the second computer data stream 1202 to be processed by the different computing device 100-2, based on a predefined concurrency threshold. A predefined concurrency threshold may be as described above with respect to method 1100. For example, if a predefined concurrency threshold of 5 has been previously defined, and computing device 100-1 is already processing 5 data streams (e.g. a first data stream 1201 representing 5 data streams) then computing device 100-1 may decide not to process further incoming data streams (e.g. a second data stream 1202 representing one or more data streams) concurrently with the one or more data streams it is already processing. Computing device 100-1 may send the incoming data streams (e.g. the second computer data stream 1202) to be processed by a different computing device, such as computing device 100-2. Computing device 100-1 may decide to automatically send the second computer data stream 1202 to be processed by computing device 100-2 e.g. without generating a second data sequence and/or sending the second data sequence to prediction model 1210 if computing device 100-1 is already processing a number of computer data streams equal to the concurrency threshold.

In some embodiments, prediction model 1210 is configured to predict a change in at least one metric associated with processing the second computer data stream 1202 upon initiating processing of the second computer data stream 1202 concurrently with processing the first computer data stream 1201. The predicted change may be based at least in part on the first data sequence and/or the second data sequence. For example, a change in IOPS for processing both the first and second data streams may be predicted, which may indicate how concurrent processing of both data streams affects the total number of required input/output operations of each data stream. In some embodiments, this may improve an efficiency (such as a runtime efficiency and/or power consumption efficiency) of computing device 100-1, for example by deciding to process data streams for which read/write operations can be performed on a same memory block.

In some embodiments, the at least one metric associated with processing the first computer data stream 1201 comprises a duration for processing the first computer data stream 1201. As discussed above, the duration may be an initially assigned random duration. Prediction model 1210 may be configured to predict a change in a first duration for computing device 100-1 to process the first computer data stream 1201, the predicted change based at least in part on the first data sequence, the second data sequence, and/or a second duration for the computing device to process the second computer data stream.

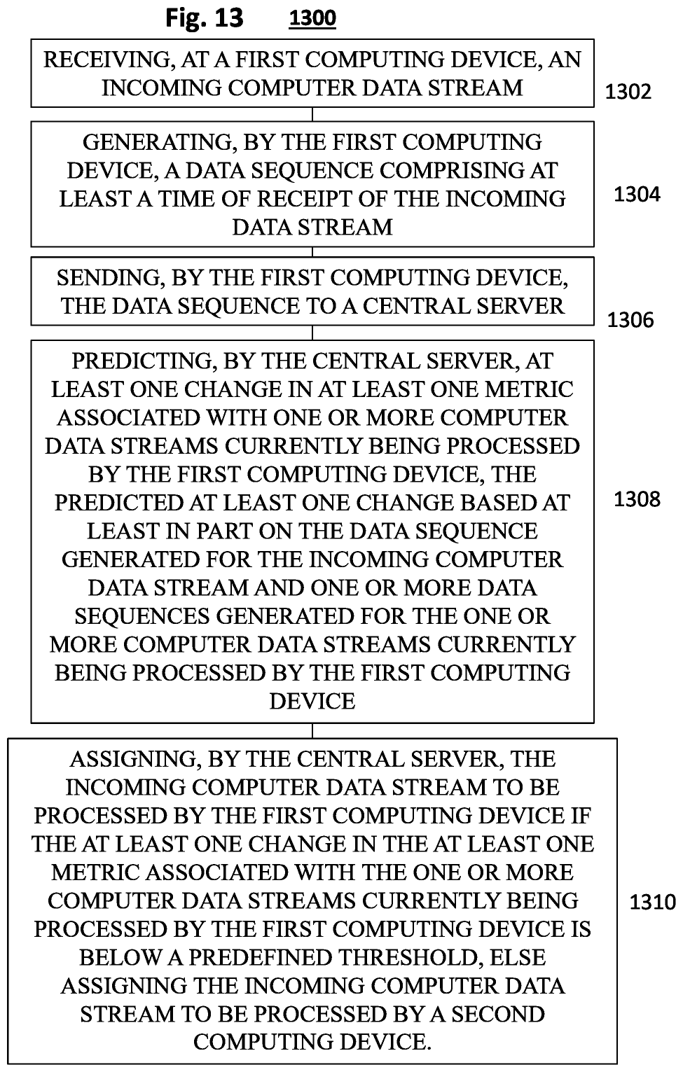

FIG. 13 is a flowchart of a computer implemented method 1300 for directing incoming computer data streams or interactions in a network of computing devices, according to some embodiments of the invention. The one or more computing devices may be, for example, agent terminals 6, and the incoming data streams may represent communications/interactions 20 as described with respect to FIG. 10. The system of FIG. 12 may be used to implement method 1300.

Method 1300 may include receiving, at a first computing device, an incoming computer data stream (Step 1302). The computing device may already be processing one or more previously received computer data streams upon receiving the incoming data stream.

Method 1300 may include generating, by the first computing device, a data sequence comprising at least a time of receipt of the incoming computer data stream (Step 1304). The data sequence may be as described herein for Step 1104 of method 1100 shown in FIG. 11.

Method 1300 may include sending, by the first computing device, the data sequence to a central server (Step 1306). The central server may be, or may include elements of, a computing device 100 shown in FIG. 1.

Method 1300 may include predicting, by the central server, at least one change in at least one metric associated with one or more computer data streams currently being processed by the first computing device, the predicted at least one change based at least in part on the data sequence generated for the incoming computer data stream and one or more data sequences generated for the one or more computer data streams currently being processed by the first computing device (Step 1308). For example, the computing device may already be processing one or more computer data streams, and may have generated data sequences for these computer data streams as and when they were received. The central server may include a prediction model as described herein for Step 1110 of method 1100 shown in FIG. 11, and/or prediction model 1210 described with respect to FIG. 12.

Method 1300 may include assigning, by the central server, the incoming computer data stream to be processed by the first computing device if the at least one change in the at least one metric associated with the one or more computer data streams currently being processed by the first computing device is below a predefined threshold, else assigning the incoming computer data stream to be processed by a second computing device (Step 1310). For example, if a predicted total change in duration for concurrently processing the incoming data stream alongside the one or more computer data streams already being processed by the computing device is above a predefined threshold (e.g. 15 minutes) the incoming computer data stream may be routed to a different computing device for processing.

In some embodiments, the central server automatically assigns the incoming computer data stream to be processed by the second computing device, without predicting the at least one change in the at least one metric associated with the one or more computer data streams currently being processed by the first computing device, if the number of the one or more computer data streams currently being processed by the first computing device is at a predefined concurrency threshold. For example, if a concurrency threshold of 5 has been previously predefined and the first computing device is already processing 5 computer data streams, method 1300 may include automatically assigning an incoming 6^{th} computer data stream to be processed by a different computing device without predicting at least one change in the least one metric associated with the one or more computer data streams already being processed by the first computing device (e.g. without performing Step 1308).

In some embodiments, the central server may perform a prediction in respect of the impact of assigning the incoming computer data stream to the second computing device (e.g. repeating method 1300 for the second computing device as if it were the first computing device). It may take several iterations to identify a computing device of the network which can process the incoming computer data stream without adversely affecting processing of one or more data streams already being processed by a computing device of the network.

### Example Embodiments

Discussed now are example embodiments of the invention for the case where the data streams represent communications/interactions (such as chats) being handled in a contact centre. It will be appreciated that in view of the foregoing description embodiments of the invention are not limited to communications in a contact centre, and may be applied to any situation in which concurrent processing of data streams occurs.

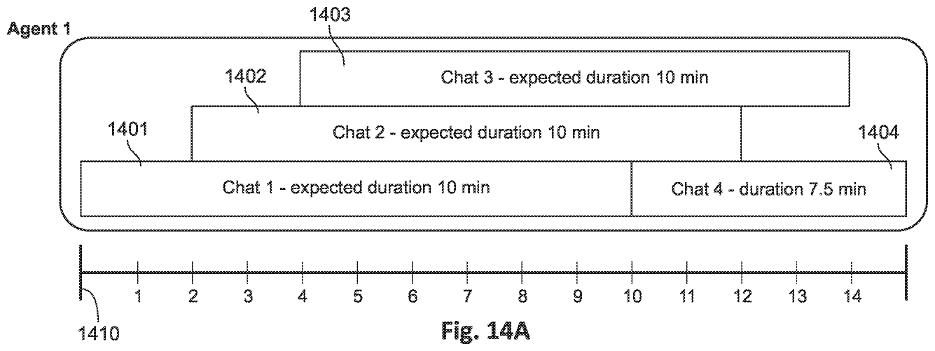

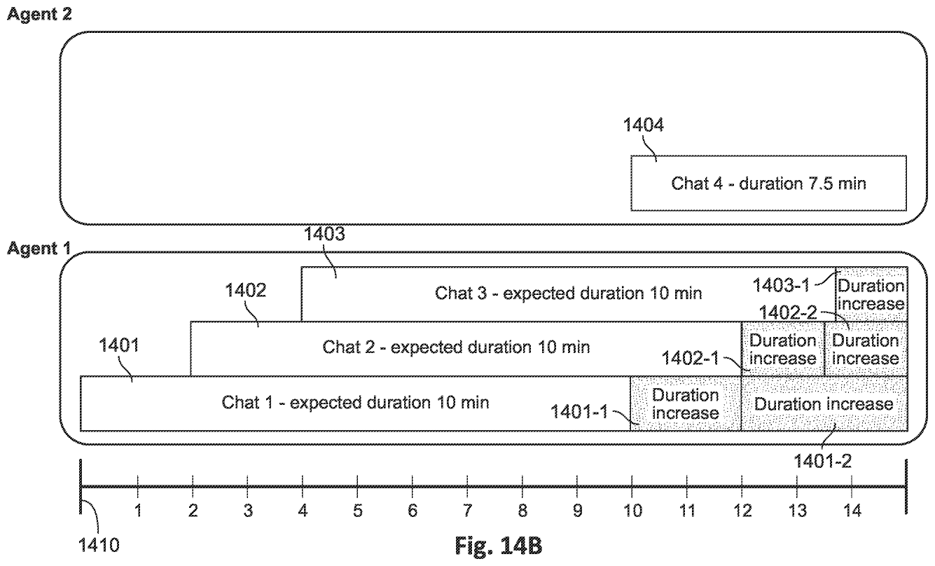

FIG. 14A shows a regular and example simulation of agent availability, according to methods known in the art. The specific time intervals and interactions are examples only; other time periods and activities may be used. In FIG. 14A, a 15 minute time interval 1410 is considered. A single agent (Agent 1) receives a first chat 1401 for handling/processing from time zero. The expected duration for the first chat 1401 is 10 minutes. The expected duration may be based on other simulations (e.g. based on historic production data), or may be a randomly assigned duration as discussed herein. At time T=2 minutes (e.g. 2 minutes after receiving the first chat 1401) a second chat 1402 is received for handling/processing by the agent. The expected duration for second chat 1402 is 10 minutes. Agent 1 may handle first chat 1401 and second chat 1402 concurrently, for example dividing their attention between the first chat and the second chat. At time T=4 minutes (e.g. 4 minutes after receiving the first chat 1401, and 2 minutes after receiving the second chat 1402), a third chat 1403 is received by the agent for handling/processing. Agent 1 may handle first chat 1401, second chat 1402, and third chat 1403 concurrently, for example dividing their attention between the first chat, second chat, and third chat. At time T=10 minutes, agent 1 may finish handling first chat 1401 (as expected), and may receive a new (fourth) chat 1404, with an expected duration of 7.5 minutes. Agent 1 may handle second chat 1402, third chat 1403, and fourth chat 1404 concurrently, for example dividing their attention between the second chat, third chat, and fourth chat. At time T=12 minutes, agent 1 may finish handling second chat 1402 as expected, and may continue to concurrently handle third chat 1403 and fourth chat 1404. At time T=14 minutes, agent 1 may finish handling of third chat 1403 as expected. Agent 1 may then continue handling fourth chat 1404 for the remainder of the expected duration. The simulation of FIG. 14A shows that a single agent can handle these 4 chats within the 15 minute interval (with chat 4 continuing to be handled into the next interval). It should be noted that this simulation is a “naïve” simulation as it does not account for the impact of concurrent assignment of chats.

FIG. 14B shows an altered simulation to that of FIG. 14A, according to some embodiments of the invention. The times of receipt of chats 1401, 1402 and 1403 are the same as in FIG. 14A. However, embodiments of the invention provide predictions of duration increases as a result of concurrent processing of chats. For example, the simulation in accordance with embodiments of the invention predicted that the first chat 1401 would require a duration increase 1401-1 of 2 minutes due to the effect of concurrently handling the second chat 1402 and/or the third chat 1403. During the simulation, embodiments of the invention are given data sequences for the chats (data streams) as they are generated and predicts the impact of an assignment as it occurs. Durations are then updated, resulting in a more accurate and reliable simulation, where concurrent assignments impact each other in terms of duration. For example, the simulation also predicted a further increase in duration 1401-2 in the first chat 1401 due to the effect of concurrently handling the second chat 1402 and/or the third chat 1403. The simulation predicted increases in duration 1402-1 and 1402-2 in the second chat 1402 due to concurrent handling of the first chat 1401 and/or third chat 1403. The simulation predicted an increase in duration 1403-1 in the third chat 1403 due to concurrent handling of the first chat 1401 and/or second chat 1402. The simulation in accordance with embodiments of the invention determined that the fourth chat 1404 should be assigned to a second agent (agent 2) for handling, because the increases in duration to the first chat 1401 meant that agent 1 was already concurrently handling 3 communications at the time (T=10) when the fourth chat arrived. Accordingly, for the same 15 minute interval, the simulation in accordance with embodiments of the invention gives a different required staffing (2 agents) compared to the existing simulation techniques shown in FIG. 14A. Embodiments of the invention may thereby improve existing scheduling technologies, data distribution technologies, and KPI monitoring/service metric predictions.

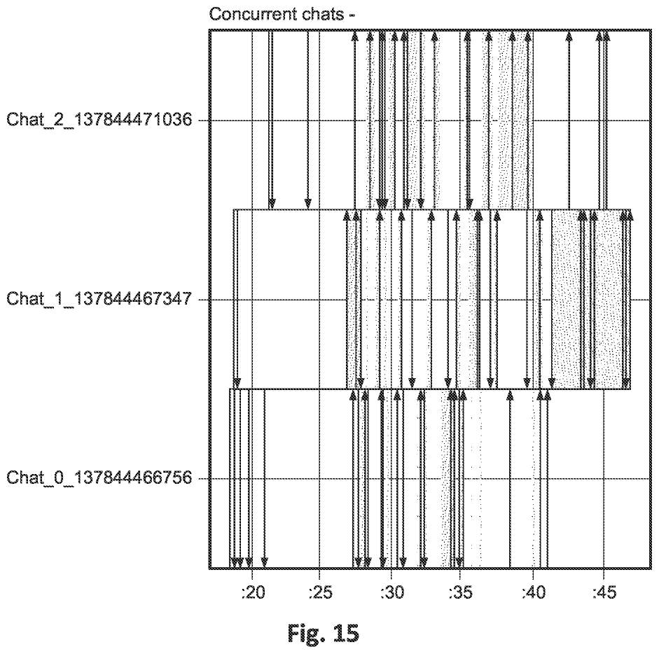

FIG. 15 shows a visual representation of an agent concurrently handling three chats. The areas of stippling (dots) represent agent focus. Upward pointing arrows represent messages being sent by the agent to the customers, while downward pointing arrows represent incoming messages coming from the customer to the agent. It can be seen that once the agent is assigned to a chat, the agent switches between the different contacts, until completion. FIG. 15 is taken from the WFM system's perspective, e.g. the agent's computer's perspective, and is not taken from the agent's perspective, and displays also the time spent waiting for an agent by the chat customers.

Table 3 shows a representation of the data as sequences of events from the agent's computer's perspective, in accordance with embodiments of the invention. Each event/data stream is received at the agent's computing device and a data sequence is generated by the computing device, which includes at least a time of receipt of the computer data stream. Each event/data sequence can contain multiple different fields of information. An event may include, for example, the start or end of a customer interaction session. The different events and/or fields of information may be customizable, and may allow accounting for a varying amount of information.

TABLE 3

[Embedding_event(time_since_start=0, start_or_end=′start′, skill=′Chat
CS′, index_in_group=0, contact_id=137844467347, date=′2021-05-20′),
Embedding_event(time_since_start=28, start_or_end=′start′, skill=′Chat
CS′, index_in_group=1, contact_id=137844466756, date=′2021-05-20′),
Embedding_event(time_since_start=35, start_or_end=′start′, skill=′Chat
CS′, index_in_group=2, contact_id=137844471036, date=′2021-05-20′),
Embedding_event(time_since_start=851, start_or_end=′end′, skill=′Chat
CS′, index_in_group=1, contact_id=137844466756, date=′2021-05-20′),
Embedding_event(time_since_start=1102, start_or_end=′end′, skill=′Chat
CS′, index_in_group=2, contact_id=137844471036, date=′2021-05-20′),
Embedding_event(time_since_start=1203, start_or_end=′end′, skill=′Chat
CS′, index_in_group=0, contact_id=137844467347, date=′2021-05-20′)]

In the example of Table 3, it can be seen how three chats are assigned (and thus distributed to the agent's computer) to the agent during 35 seconds, and how they complete one by one. Note that the index_in_group field is different between the previous visualization in FIG. 15 and the above event sequence, again, due to the difference in perspective.

Historical sequences as presented in Table 3, may be transformed into multiple instances with 3 parts each—x_sequence, x_identifier, y_duration, as shown in Table 4. Each of the sequences may be an x_sequence, an x_identifier may be an identifier for the chat that is the next to end, stating for the trained algorithm that this is the chat to predict for, and a y_duration may be the target for prediction, which in table 4 is also referred to as “completion time to predict”. An event can be, for example, the assignment or distribution of a new chat (‘start’ from the agent's perspective) and/or the completion of an assigned chat (‘end’ from the agent's perspective). Every “end” event may be used for generating a training sample, in which the leading sequence of events may be coupled with the index in group of the event whose end it is desired to predict. The sequence presented above may be sampled into three training samples, one for each completion of the three chats. It should be noted that the three “completion time to predict” values correspond to the duration of each chat from the agent's perspective.

TABLE 4

**************************************************
sequence:
Embedding_event(time_since_start=0, start_or_end=′start′, skill=′Chat
CS′, index_in_group=0, contact_id=137844467347, date=′2021-05-20′)
Embedding_event(time_since_start=28, start_or_end=′start′, skill=′Chat
CS′, index_in_group=1, contact_id=137844466756, date=′2021-05-20′)
Embedding_event(time_since_start=35, start_or_end=′start′, skill=′Chat
CS′, index_in_group=2, contact_id=137844471036, date=′2021-05-20′)
identifier: 1
completion time to predict: 851
**************************************************
sequence:
Embedding_event(time_since_start=0, start_or_end=′start′, skill=′Chat
CS′, index_in_group=0, contact_id=137844467347, date=′2021-05-20′)
Embedding_event(time_since_start=28, start_or_end=′start′, skill=′Chat
CS′, index_in_group=1, contact_id=137844466756, date=′2021-05-20′)
Embedding_event(time_since_start=35, start_or_end=′start′, skill=′Chat
CS′, index_in_group=2, contact_id=137844471036, date=′2021-05-20′)
Embedding_event(time_since_start=851, start_or_end=′end′, skill=′Chat
CS′, index_in_group=1, contact_id=137844466756, date=′2021-05-20′)
identifier: 2
completion time to predict: 1102
**************************************************
sequence:
Embedding_event(time_since_start=0, start_or_end=′start′, skill=′Chat
CS′, index_in_group=0, contact_id=137844467347, date=′2021-05-20′)
Embedding_event(time_since_start=28, start_or_end=′start′, skill=′Chat
CS′, index_in_group=1, contact_id=137844466756, date=′2021-05-20′)
Embedding_event(time_since_start=35, start_or_end=′start′, skill=′Chat
CS′, index_in_group=2, contact_id=137844471036, date=′2021-05-20′)
Embedding_event(time_since_start=851, start_or_end=′end′, skill=′Chat
CS′, index_in_group=1, contact_id=137844466756, date=′2021-05-20′)
Embedding_event(time_since_start=1102, start_or_end=′end′, skill=′Chat
CS′, index_in_group=2, contact_id=137844471036, date=′2021-05-20′)
identifier: 0
completion time to predict: 1203

Table 4 shows embodiments of the invention predicting chat 1 to complete after 851 seconds, chat 2 to complete after 1102 seconds and chat 0 to complete after 1203 seconds. The predictions are based on the concurrency of the remaining chats.

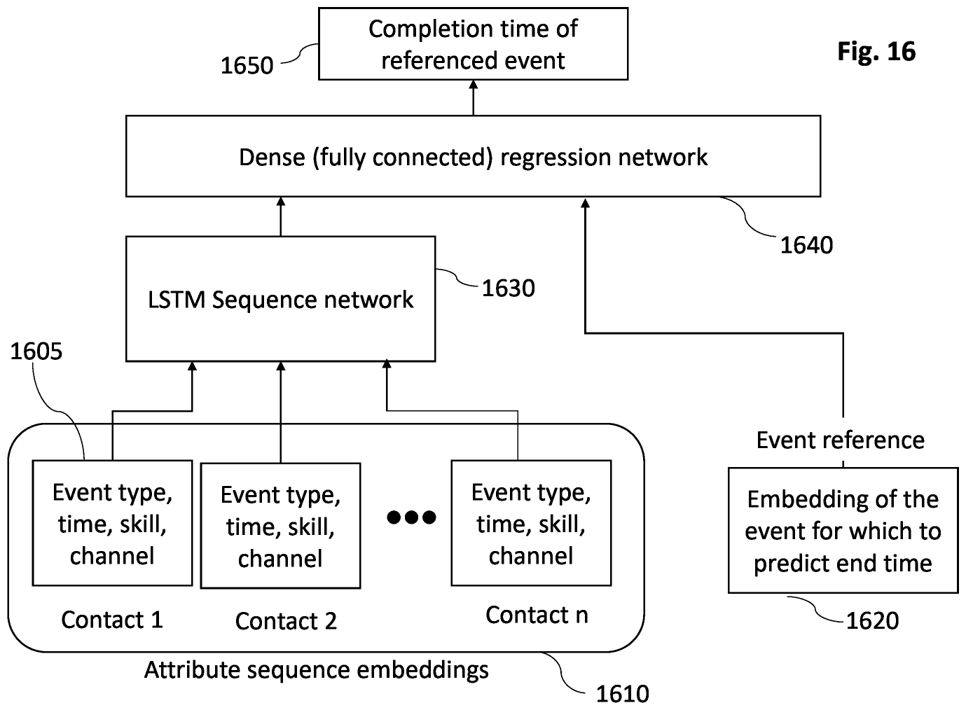

FIG. 16 shows an example architecture of a prediction model according to some embodiments of the invention. One or more functions of the prediction model may be executed by a computing device, such as computing device 100 shown in FIG. 1.

The prediction model may include attribute sequence embedding 1610, which may take sequences of events such as those shown in Table 4 and embed them as data sequences 1605 relating to one or more (e.g. n, where n is an integer) contacts. The sequence of events may be transformed into vectors through concatenating numerical values and transforming categorical fields with one-hot encoding, for example embodiments of the invention may represent the skill field in the embeddings with a binary value that corresponds to this skill (e.g. if there are three skills, they may be represented by the one-hot encoding [‘00’, ‘01’, ‘10’]). These sequences may be fed into a long short term memory (LSTM) network 1630. The LSTM network may process the sequence, e.g. element by element, updating its inner/hidden state to represent the content of the sequence up to this point, finally holding an inner state (e.g. vector) compressing the content of the sequence into a vector.

An output of the LSTM may be used as a vector representation for the sequences, and may be concatenated with an event reference 1620, stating for which item in the sequence a prediction is to be performed for.

The concatenated vector may be used as input to a dense (e.g. fully connected) regression layer 1640, which in turn may output a prediction for the expected duration of the referenced contact.

The architecture shown in FIG. 16 allows the prediction model to predict the impact of a new assignment on the assigned agent and the contacts that the agent is already handling. The simulation moves from event to event, where, as discussed an event can be, for example, the assignment of a new chat and/or the completion of an assigned chat. As assignments occur, sequences are continued. At each assignment, the system may query the model with the sequence of events, and the model may compute the expected duration for each of the concurrent contacts. These predictions may be returned to the simulation, which may in turn update the completion times of contacts, and refrain from assigning contacts to agents that have reached their maximal concurrency. The query may include a sequence of events (e.g. a data sequence) from the agent perspective, showing what the agent has been working on, what the agent is currently working on, and the duration of contacts that have completed since the last time the agent was at a concurrency of 0.

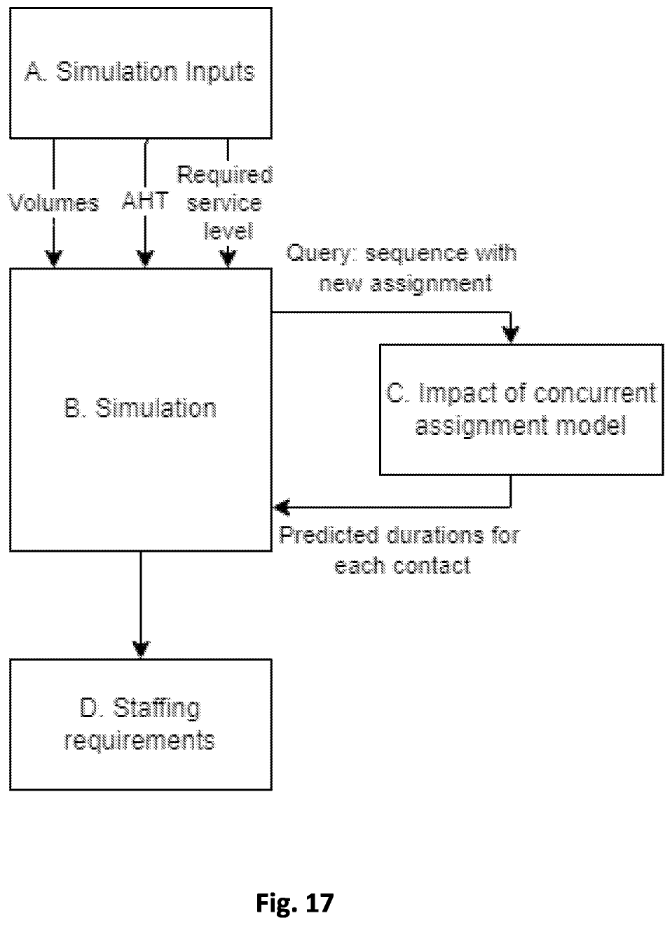

FIG. 17 shows a high-level overview of how a system for predicting a change in processing a first computer data stream upon receipt of a second computer data stream may be integrated into a system for allocating resources for a plurality of given time intervals, according to some embodiments of the invention.

At A, inputs may be input to a simulation B. The inputs may be inputs as discussed herein for staffing requirement generation, such as volume (number of calls) as well as the AHT (average handling time). These inputs may be provided for each skill and may be used to generate the arrival times of contacts, as well as their initial duration within the simulation. In a similar fashion, service targets such as ASA, SLA or response time may be provided to the simulation, determining what are the targets that the simulation process must staff for. See for example, A.1 and A.2 of FIG. 2.

At B a simulation is run. The simulation may be a simulation as described herein, for example a method as shown in FIG. 5. In some embodiments, the simulation may be a standard simulation module as used in the industry. According to some embodiments, once a concurrent assignment is made, the simulation is interrupted midflow and a query is sent to C (representing an impact of concurrent assignment model, in accordance with embodiments of the invention). This query may contain the series of events from the agent's perspective, starting from the agent's last idle time until the current assignment. The simulation module B will wait for the updated predictions for completion times from module C, and once they are received, will update the future completion times planned for the assigned contacts to the completion times predicted by module C.

At C, which is a module configured to execute an impact of concurrent assignment model, a query represented as a sequence of events (similar to that depicted in Table 3) is received. Module C may transform the sequence into multiple pairs having shape (sequence, identifier), using the full sequence that was received and an identifier for every contact in the sequence that has not completed yet. For each pair, i.e, for each contact in the sequence that has not completed yet, the model will predict a completion time, for example by inputting these pairs into the model described schematically in FIG. 16. These completion times may be returned to module B (Simulation), as represented by the arrow in FIG. 17 with the statement “predicted duration for each contact”. Module B may then resume the simulation using the updated prediction times. The predicted duration may, for each contact in the query that has not been completed, be the expected duration at the time of the query since the contact start.

At D, staffing requirements may be generated. Once the simulation at B concludes its process, the module at D may output the number of agents needed for each skill, or counts for multi-skill agents, required to meet the required service level.

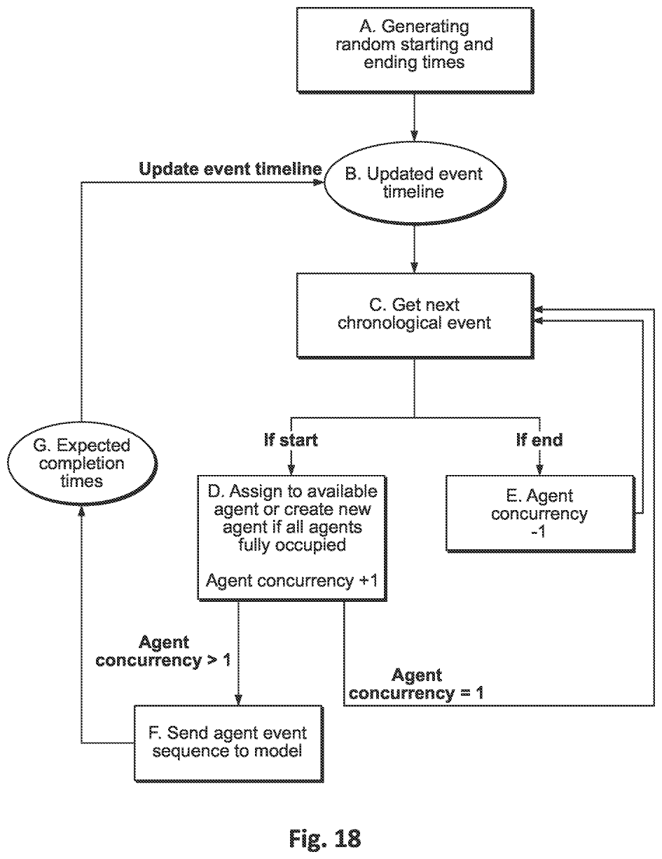

FIG. 18 shows a focused view of module B of FIG. 17.

At A, random starting and ending times may be generated. Given the provided volumes and average handling times (AHT) the first step in running the simulation is generating arrival times for each contact, and generating random durations for each contact. Depending on the implementation of the simulation, this generation can use different distributions as sources for random numbers, or distribute the contacts evenly within the time interval simulated. It will be appreciated that a specific implementation of achieving the randomization is not required, and any implementation chosen will work with embodiments of the invention. The output of step A may be a sorted (e.g. chronologically sorted) timeline of events, as represented by B in FIG. 18.

In FIG. 18, B may represent an event timeline, such as an updated event timeline. Given the generated starting and end times (e.g. from A), a timeline of expected events may be generated. This timeline may include the arrival time of contacts, as well as the completion time of these contacts, but will be subject to change and may be updated after each assignment. Expected durations are assumed the time needed for an agent to handle a contact at a concurrency of 1 (e.g. forecasted based on machine learning or other model: in some embodiments, durations are simulated based on assumptions relating to historical data, e.g. by being drawn from a normal distribution with the mean and variance calculated based on historical durations). Module B will supply the next event to the simulation as it progresses, while making changing completion times possible via predictions from F.

At C, the next chronological event may be retrieved. The simulation may be built in an iterative sequential manner, where time is not iterated through, but events are. Accordingly, the algorithm run time may depend on the number of events, and not on the total duration. For two chats, there may be only four events to process, irrelevant of the duration of the interval or the resolution of time the model is working within. In this way, the model may forecast the duration so as to provide an updated end time. For example, when a new work item is assigned to an agent, the system may directly update the end time of all the other work items currently connected with this agent based on the forecasting of the machine learning model. Every time module C will be reached in the flow, it will generate the next event and remove it from the beginning of the timeline. In the following implementation of a simulation, the next event can be either a start of a contact or a completion (e.g. an end event). Other event types may be considered by embodiments of the invention, such as, but not limited to, context switches, focus time per message, events for incoming and out-going messages, textual complexity of each message, etc.

If the next event is a start event, the contact will be assigned to an agent at D. The contact may be assigned to an available agent, e.g. an agent with concurrency lower than a predefined maximal concurrency (such as 3, for example). If there are no available agents, e.g. all the agents are occupied, a new agent may be added. In some embodiments, if there are no available agents there may be a wait for an agent to become available and iterating over the simulation as part of a search process. In some embodiments, the simulation starts with 0 agents and adds agents on the fly as they are required. In some embodiments, the available agent personnel may be set at the beginning of the run and multiple staffings (e.g. different combinations of the available personnel) may be tried iteratively, and the best one (e.g. optimal balance between required personnel and expected volume of chats to be handled). Accordingly, the algorithmic approach according to embodiments of the invention does not depend on a specific simulation implementation. For example, in some embodiments, a service matrix could be used by the simulation to adjust the number of employees automatically. Upon assignment of a contact to an agent, the concurrency of that agent may be incremented by 1. If following the assignment and increment the available agent is at a concurrency of 1, the completion time generated by the simulation will be assumed to be the accurate completion time. In this case the simulation will go back to C to get the next event. If the agent concurrency is larger than 1, a sequence of events, as referenced earlier, may be sent to a prediction model at F, to assess the impact of the concurrent assignment.

In case of an end event, the concurrency of the agent assigned to the event will be decreased by 1 at E, rendering the agent available in case they were at the maximal concurrency.

At F, agent event sequences may be sent to a prediction model in accordance with embodiments of the invention. The sending of data sequences to the prediction model disrupts traditional simulation methods with the usage of machine learning models for predictions of items that cannot be simulated. A sequence of events, such as depicted in Table 3 is sent to the model, which performs the process described in FIG. 17, block C.

At G, completion times are output from the machine learning model on the sequence of events generated by the simulation. Their value depends both on decisions made within the simulation, depending on availability of agents, and on the trained model predictions. These updated predictions are then pushed into module B, resulting in an updated timeline that accounts for the impact of the concurrent assignment.

Table 5 summarizes example data used by embodiments of the invention, with reference to FIGS. 16 and 17.

TABLE 5

| Block | | | |
|---|---|---|---|
| Numbering | Block Name | Shape | Description |
| FIG. 16.A. | Volumes | \|skills\| | For each of the tenant skills, the number of |
| | | | expected incoming contacts during the |
| | | | interval. |
| FIG. 16.A. | AHT | \|skills\| | The average duration of contacts during this |
| | | | interval, that may be used to generate the |
| | | | random durations for the simulated interval |
| FIG. 16.A. | Required | \|service | The method used by the system user to define |
| | service level | metrics\| | the quality of service to be provided. In some |
| | | | embodiments of the simulation, the number of |
| | | | agents is not fixed per simulation run, but |
| | | | increases as agents are needed to satisfy the |
| | | | required service level. |
| FIG. 16.B. | Query | \|Sequence | The query may include the sequence of events |
| | | length\| × | the assigned agent has gone through, since the |
| | | \|Fields\| | last time he has been at a concurrency of 0. |
| | | | An example of such a query can be seen in |
| | | | Table 4. |
| FIG. 16.C. | Predicted | \|number of | For each of the contacts that have not been |
| | Durations | contacts | completed yet within the query, the algorithm |
| | | that were not | may provide a prediction of the expected |
| | | completed | duration. |
| | | in the full | |
| | | sequence | |
| | | length\| | |
| FIG. 16.D. | Staffing | \|skills\| | For each skill, the number of agents needed |
| | requirements | | in-order to reach the required service level |
| FIG. 17.B. | Updated | 2 × | A sorted sequence of start and end events for |
| | event timeline | \|volumes\| | each contact. End events can be adjusted as |
| | | | the contact is assigned and the model |
| | | | provides updated predictions. |

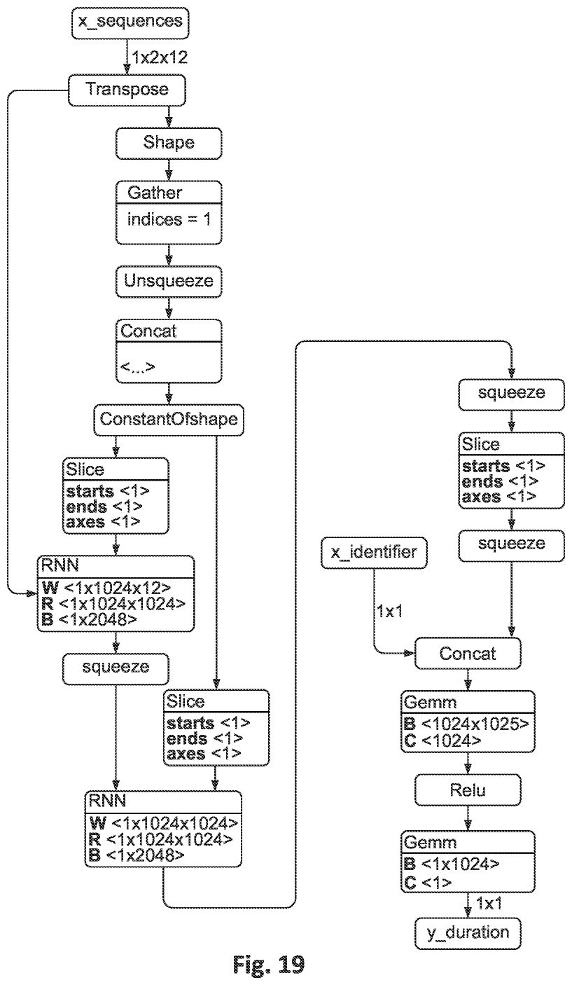

FIG. 19 is a diagram showing the structure of a neural network according to an embodiment of the present invention. Such a neural network may be a component of the prediction model herein described. A neural network according to embodiments of the invention may be a dense (e.g. fully-connected) neural network (or have at least one dense/fully-connected layer) as shown in FIG. 7. The structure in FIG. 19 represents a possible modeling approach for the model described in FIG. 16. The inputs to the neural network may be x_sequences and x_identifier, and the network may give a final output, y_duration.

The boxed mathematical operators Transpose, Shape, Gather, unsqueeze, and concat(enate) correspond to calculations and actions performed on the data and are straight forward mathematical operators over vectors or matrices known to the skilled person, which need not be further defined. Other boxes appearing in FIG. 19 are now discussed.

RNN (LSTM)—Long short-term memory (LSTM) is an artificial neural network used in the fields of artificial intelligence and deep learning. Unlike standard feedforward neural networks, LSTM has feedback connections. Such a recurrent neural network (RNN) can process not only single data points (such as images), but also entire sequences of data (such as speech or video).

GEMM (General Matrix Multiplications)— Dense layers (also known as fully connected layers) are connected to each other and perform a matrix multiplication process, combined with a vectoric addition (bias). Standard neural network building block.

Relu—In the context of artificial neural networks, the rectifier or ReLU (Rectified Linear Unit) activation function is an activation function defined as the positive part of its argument, as described previously herein.

Discussed now are the results of tests showing a comparison in terms of duration error when using the method in accordance with embodiments of the invention, compared to the average handling time. The results presented are complete outputs of the machine learning model trained on real production data in accordance with embodiments of the invention.

Table 6 provides a look at the contact level, showing for each item what was the actual duration (ground truth), what was the model prediction (prediction) provided by embodiments of the invention, and what was the AHT for the interval, which is the commonly used baseline in most systems. This table provides a small sample of the data and includes columns with absolute error values and other measures. This unaggregated data is presented to make the aggregated analysis clearer. In this table the chat ID has been suppressed, and chats are represented instead by an index. Chats 0-4 are part of a training set, and chats 208096-208100 are part of a validation set.

TABLE 6

| | | | | actual duration | | | | | | |
|---|---|---|---|---|---|---|---|---|---|---|
| index | skill_name | date | interval | (ground truth) | prediction | AHT | abs_pred_error | abs_aht_error | pred_error | aht_error |
| 0 | Chat CS | Jan. 1, 2021 | 74 | 413 | 253 | 707 | 159 | 294 | 160 | −294 |
| 1 | Chat | Jan. 1, 2021 | 74 | 544 | 672 | 385 | 128 | 159 | −128 | 159 |
| | Sales | | | | | | | | | |
| 2 | Chat CS | Jan. 1, 2021 | 85 | 968 | 1169 | 605 | 201 | 363 | −201 | 363 |
| | TFS | | | | | | | | | |
| 3 | Chat CS | Jan. 1, 2021 | 84 | 1604 | 1202 | 808 | 401 | 795 | 402 | 796 |
| 4 | Chat CS | Jan. 1, 2021 | 85 | 1898 | 1901 | 605 | 3 | 1293 | −3 | 1293 |
| | TFS | | | | | | | | | |
| . . . | . . . | . . . | . . . | . . . | . . . | . . . | . . . | . . . | . . . | . . . |
| 208096 | Chat | Aug. 31, 2021 | 52 | 25 | 199 | 272 | 174 | 247 | −174 | −247 |
| | Fan | | | | | | | | | |
| | Seller | | | | | | | | | |
| 208097 | Chat | Aug. 31, 2021 | 53 | 314 | 199 | 235 | 114 | 79 | 115 | 79 |
| | Fan | | | | | | | | | |
| | Seller | | | | | | | | | |
| 208098 | Chat | Aug. 31, 2021 | 57 | 791 | 174 | 597 | 616 | 194 | 617 | 194 |
| | Seller | | | | | | | | | |
| 208099 | Chat CS | Aug. 31, 2021 | 91 | 1705 | 359 | 904 | 1345 | 800 | 1346 | 801 |
| 208100 | Chat CS | Aug. 31, 2021 | 0 | 5 | 359 | 496 | 354 | 491 | −354 | −491 |

Table 7 provides an aggregated view of the results of Table 6 for the validation set only, showing for each skill the support (number of contacts) and the averaged prediction error of the model predictions, as well as AHT. Results are very clearly improved by using the model according to embodiments of the invention, as compared to relying on the AHT.

TABLE 7

| skill_name | support | abs_pred_error | abs_aht_error | pred_error | aht_error |
|---|---|---|---|---|---|
| Chat CS | 10167 | 319.54588 | 1340.315 | 198.20085 | 1114.8278 |
| Chat CS | 15 | 170.2 | 922.13333 | 64.533333 | 904.8 |
| Cancelled | | | | | |
| Chat CS | 7 | 89.142857 | 230.42857 | −17.571429 | 229.85714 |
| Level 3 | | | | | |
| Chat CS TFS | 7189 | 292.2234 | 1304.9259 | 165.72764 | 1145.2877 |
| Chat Fan | 1845 | 179.6477 | 302.85041 | 15.992954 | 70.188618 |
| Seller | | | | | |
| Chat OF | 226 | 356.77434 | 274.09292 | 120.38496 | −133.84071 |
| Chat Sales | 6 | 290.33333 | 1190.6667 | 226.5 | 1189.3333 |
| Chat Seller | 455 | 161.91648 | 275.44615 | 96.217582 | 111.11868 |

Embodiments of the invention may improve the technologies of computer automation, big data analysis, and computer use and automation analysis by using specific algorithms to analyze large pools of data, a task which is impossible, in a practical sense, for a person to carry out. Embodiments may improve machine learning techniques by new uses and structures for such techniques. Machine learning methods in accordance with embodiments of the invention may be used to make predictions for expected changes which cannot be simulated, and provides predictions to support and improve the accuracy of different calling systems. Model predictions may be provided on request from the calling system iteratively as assignments are made, and the model predictions are used to automatically adjust durations within a staffing requirements simulation. Embodiments of the invention may improve existing scheduling technologies by rapidly and automatically analysing previously unutilized pools of historic data. Integration of embodiments of the invention into a contact centre environment may improve automated call-dialing technology, and improved understanding of the impacts of concurrency may improve call-routing technology. Communications handled in a contact centre involve a complex set of interactions using, for example, voice-over-IP technologies, interactive voice response (IVR) and private branch exchange (PBX). Embodiments of the invention may also be used to predict the impact of concurrent processing of a plurality of data streams by a computer processor, and may therefore improve technologies related to computational parallel processing and efficiency.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computer implemented method for, upon receipt of a second computer data stream, predicting a change in processing a first computer data stream, the method comprising:
receiving, at a computing device, the first computer data stream;
generating, by the computing device, a first data sequence comprising a time of receipt of the first computer data stream;
receiving, at the computing device, the second computer data stream;
generating, by the computing device, a second data sequence comprising a time of receipt of the second computer data stream;
sending, by the computing device, the first and second data sequences to a prediction model;
predicting, by the prediction model, at least one change in at least one metric associated with processing the first computer data stream, the predicted change based at least in part on the first data sequence and the second data sequence; and
sending, by the prediction model, to the computing device, the at least one change in the at least one metric associated with processing the first computer data stream.

2. The method of claim 1, comprising deciding, by the computing device, on the basis of the at least one change in the at least one metric associated with processing the first computer data stream, whether to process the second computer data stream concurrently with the first computer data stream, or to send the second computer data stream to be processed by a different computing device.

3. The method of claim 2, wherein deciding, by the computing device, whether to process the second computer data stream concurrently with the first computer data stream, or send the second computer data stream to be processed by the different computing device, is further based on a concurrency threshold.

4. The method of claim 1, comprising predicting by the prediction model, a change in at least one metric associated with processing the second computer data stream upon initiating processing of the second computer data stream concurrently with processing the first computer data stream, computer data stream, the predicted change based at least in part on the first data sequence and the second data sequence.

5. The method of claim 1, wherein the at least one metric associated with processing the first computer data stream comprises a duration for processing the first computer data stream, and
wherein predicting, by the prediction model, comprises predicting a change in a first duration for the computing device to process the first computer data stream, the predicted change based on the first data sequence, the second data sequence, and a second duration for the computing device to process the second computer data stream.

6. The method of claim 1, wherein the prediction model comprises one or more of: a machine learning algorithm; a regression algorithm; a deep learning algorithm; a neural network; a long short term memory neural network; a fully connected neural network; and a convolutional neural network.

7. The method of claim 1, wherein the first computer data stream represents a plurality of computer data streams being processed by the computing device, the method steps repeated for each computer data stream of the plurality of computer data streams.

8. The method of claim 1, wherein the first computer data stream and the second computer data stream represent communications being handled in a contact centre.

9. A computer implemented method for directing incoming computer data streams in a network of computing devices, the method comprising:
receiving, at a first computing device, an incoming computer data stream;
generating, by the first computing device, a data sequence comprising at least a time of receipt of the incoming computer data stream;
sending, by the first computing device, the data sequence to a server;
predicting, by the central server, at least one change in at least one metric associated with one or more computer data streams currently being processed by the first computing device, the predicted at least one change based at least in part on the data sequence generated for the incoming computer data stream and one or more data sequences generated for the one or more computer data streams currently being processed by the first computing device; and
assigning, by the central server, the incoming computer data stream to be processed by the first computing device if the at least one change in the at least one metric associated with the one or more computer data streams currently being processed by the first computing device is below a predefined threshold, else assigning the incoming computer data stream to be processed by a second computing device.

10. The method of claim 9, wherein the central server automatically assigns the incoming computer data stream to be processed by the second computing device, without predicting the at least one change in the at least one metric associated with the one or more computer data streams currently being processed by the first computing device, if the number of the one or more computer data streams currently being processed by the first computing device is at a predefined concurrency threshold.

11. The method of claim 9, wherein the central server comprises a prediction model, the prediction model comprising one or more of: a machine learning algorithm; a regression algorithm; a deep learning algorithm; a neural network; a long short term memory neural network; a fully connected neural network; and a convolutional neural network.

12. A system for predicting a change in processing a first computer data stream upon receipt of a second computer data stream, the system comprising:
a computing device; and
a prediction model;
wherein the computing device is configured to:
receive the first computer data stream;
generate a first data sequence comprising a time of receipt of the first data stream;
receive the second computer data stream;
generate a second data sequence comprising a time of receipt of the second computer data stream; and
send the first and second data sequences to the prediction model,
wherein the prediction model is configured to:
receive the first and second data sequences from the computing device;
predict at least one change in at least one metric associated with processing the first computer data stream, the predicted change based at least in part on the first data sequence and the second data sequence; and
send, to the computing device, the at least one change in the at least one metric associated with processing the first computer data stream,
wherein the computing device is further configured to receive, from the prediction model, the at least one change in the at least one metric associated with processing the first computer data stream.

13. The system of claim 12, wherein the computing device is configured to decide, on the basis of the at least one change in the at least one metric associated with processing the first computer data stream, whether to process the second computer data stream concurrently with the first computer data stream, or to send the second computer data stream to be processed by a different computing device.

14. The system of claim 13, wherein the computing device is further configured to decide whether to process the second computer data stream concurrently with the first computer data stream, or send the second computer data stream to be processed by the different computing device, based on a predefined concurrency threshold.

15. The system of claim 12, wherein the prediction model is configured to predict a change in at least one metric associated with processing the second computer data stream upon initiating processing of the second computer data stream concurrently with processing the first computer data stream, the predicted change based at least in part on the first data sequence and the second data sequence.

16. The system of claim 12, wherein the at least one metric associated with processing the first computer data stream comprises a duration for processing the first computer data stream, and
wherein the prediction model is configured to predict a change in a first duration for the computing device to process the first computer data stream, the predicted change based at least in part on the first data sequence, the second data sequence, and a second duration for the computing device to process the second computer data stream.

17. The system of claim 12, wherein the prediction model comprises one or more of: a machine learning algorithm; a regression algorithm; a deep learning algorithm; a neural network; a long short term memory neural network; a fully connected neural network; and a convolutional neural network.

18. The system of claim 12, wherein the first computer data stream represents a plurality of computer data streams being processed by the computing device.

19. The system of claim 12, wherein the first computer data stream and the second computer data stream represent communications being handled in a contact centre.

20. The system of claim 12, wherein the first computing device is configured to execute the prediction model.
